(19) United States
(12) Patent Application Publication
(10) Pub. No.: US 2026/0184734 A1
(43) Pub. Date: Jul. 2, 2026

(54) SUPRAMOLECULE COMPOUND, TWO-DIMENSIONAL RARE EARTH OXYSALT AND PREPARATION METHOD THEREFOR

(71) Applicant: SHENZHEN UNIVERSITY, Shenzhen, Guangdong (CN)

(72) Inventors: Xiaopeng LI, Shenzhen (CN); Xiujun YU, Shenzhen (CN); Heng WANG, Shenzhen (CN); Hao FU, Shenzhen (CN); Zhi CHEN, Shenzhen (CN)

(73) Assignee: SHENZHEN UNIVERSITY, Shenzhen, Guangdong (CN)

(21) Appl. No.: 18/852,632

(22) PCT Filed: Jun. 28, 2023
(86) PCT No.: PCT/CN2023/103349

§ 371 Date: Sep. 30, 2024

(30) Foreign Application Priority Data
Apr. 6, 2023 (CN) 202310355484.0

(51) Int. Cl. C07F 15/00; C01B 25/45; C01F 17/30; C07F 5/00

(52) U.S. Cl. CPC C07F 15/0053; C01B 25/451; C01F 17/30; C07F 5/00; C01P 2002/77; C01P 2002/86

(57) ABSTRACT

A supramolecule compound, a two-dimensional rare earth oxysalt, and a preparation method therefor are provided. By utilizing a series of π-conjugated planar supramolecule compounds as synthesis templates, a variety of novel two-dimensional rare earth oxysalts can be produced. By carefully fine-tuning the properties of the supramolecule compound template, along with the types of oxoanion and organic amine, it is possible to effectively and precisely obtain two-dimensional rare earth oxysalts with diverse structures. This template-based synthesis strategy, leveraging supramolecule compounds, is highly versatile and applicable to all rare earth elements. It enables the preparation of two-dimensional rare earth oxysalts with uniform structures, containing either a single rare earth element or multiple elements, and allows for precise control over the material's properties. The synthesis strategy not only facilitates the creation of structurally diverse two-dimensional rare earth oxysalts but also supports in-depth research into the structure-function relationships of these materials.

### TECHNICAL FIELD

The present disclosure relates to the technical field of metal oxysalts, in particular to a supramolecule compound, a two-dimensional rare earth oxysalt and a preparation method therefor.

### BACKGROUND

Metal oxysalts are the most abundant and widely used materials in nature. Among them, oxoanion groups such as PO₄³⁻, PO₃³⁻, SO₄²⁻, SO₃²⁻, BO₃³⁻, etc. form metal oxysalts with rich and diverse structures by coordination bonds with metal cations. Metal oxysalts such as zeolite molecular sieves, dihydrogen phosphate potassium (KDP) second-order nonlinear optical crystals, and barium titanate (BaTiO₃) crystals with excellent piezoelectric and ferroelectric properties, are widely used in daily life and industrial production. In addition, nonlinear optical crystals such as lithium triborate (LBO), barium metaborate (BBO) and potassium fluoroboroberylate (KBBF) based on metal oxysalts have played an irreplaceable role in the field of optical materials. Compared with organic compounds, metal-organic complexes and cluster compounds, these metal oxysalts exhibit higher thermal stability, water stability, acid and alkali stability, as well as higher optoelectronic damage thresholds and superior optoelectronic properties, and thus have received extensive attention and research.

Compared with the aforementioned main group and transition metal oxysalts, rare earth oxysalts integrate the rich optical, electrical, magnetic and catalytic properties of rare earth elements, unique 4f electron configuration, larger coordination number, and longer M-O bond length. As a result, they can form more diverse topological structures, and have important applications in optics, electronics, magnetism, and catalysis. Many rare earth oxysalts have already been industrialized and are applied in daily life, such as rare earth permanent magnets represented by samarium-cobalt permanent magnets, magneto-optical crystals represented by terbium gallium garnet (TGG), laser crystals represented by neodymium-doped yttrium aluminum garnet (Nd:YAG), and rare earth phosphors represented by rare earth garnet (YAG:Ce), and so on. In addition, research related to rare earth oxysalts has become a frontier research hotspot both domestically and internationally. Relevant studies have shown that adding organic amines as structure-directing agents in the synthesis process can yield rare earth oxysalts. However, this synthesis method is not universal and can only produce a limited number of rare-earth oxysalts with three-dimensional structures. In addition, the regulation mechanism of organic amine structure-directing agents on rare earth oxysalts is still unclear, making it difficult to precisely prepare structurally diverse rare-earth oxysalts, which hinders the establishment of structure-property relationships in these materials. Therefore, a key challenge in the prior art is how to develop new synthesis methods to precisely control the structure and properties of rare earth oxysalts.

The controllable preparation of two-dimensional rare earth oxysalts is an inevitable path for the development of structured rare earth materials. Since the discovery of graphene in 2004, two-dimensional materials have attracted extensive attention due to their unique electronic structures and excellent chemical, optical, and physical properties. However, as mentioned above, most synthetic strategies are limited to three-dimensional rare earth oxysalts and amorphous structures, mainly due to the complexity and diversity of bonding types between rare-earth metals and oxoanions as well as the uncertainty in their coordination numbers. At present, only a few types of two-dimensional rare earth inorganic salts have been developed and synthesized, such as rare earth chalcogenides, layered rare earth hydroxides (LReHs), and rare earth oxyhalides (ReOX, X=F, Cl, Br, etc.), etc. The layered structural units of the three types of two-dimensional rare earth materials mentioned above mostly have similar structures, lacking diversity, and only a very limited number of two-dimensional rare earth materials have well-defined crystal structures. Additionally, only a few specific rare-earth metal elements can form two-dimensional materials, and so far, the preparation of two-dimensional materials from the entire series of rare-earth metals has not been achieved. Compared with rare earth chalcogenides, layered rare earth hydroxides, and rare earth oxyhalides, rare earth oxysalts have more diverse structures due to the rich coordination modes of oxoanions and the flexible coordination numbers of rare-earth ions. They also exhibit higher stability, making them suitable for use as deep-ultraviolet second-order nonlinear optical crystals, indicating a promising application potential for these rare-earth oxysalts. However, due to the complexity and diversity of bonding types between rare-earth metals and oxoanions, the variability in coordination geometries, and the uncertainty in coordination numbers, the preparation of two-dimensional rare-earth oxysalts is extremely challenging, and related research is still in its infancy. Therefore, how to controllably construct two-dimensional rare earth oxysalts with excellent functionality and precise structure is a scientific challenge in the field of structured rare-earth materials that urgently needs to be addressed.

### SUMMARY

In view of the shortcomings of the prior art, a purpose of the present disclosure is to provide a supramolecule compound with a π-conjugated planar structure, a two-dimensional rare earth oxysalt and a preparation method therefor, aiming to solve the problem of difficult preparation and unregulated structure of two-dimensional rare earth oxysalts due to that the rare earth metals and oxoanions have complex and diverse bond types, variable coordination geometry, and uncertain coordination numbers.

The technical schemes of the present disclosure are as follows:

The present disclosure provides a supramolecule compound with π-conjugated planar structure, and a structural formula of the supramolecule compound is selected from one or more of T1, T2, T3, T4, T5, T6, T7, T8, T9, T10, T11. T12 T13 T14 and T15:

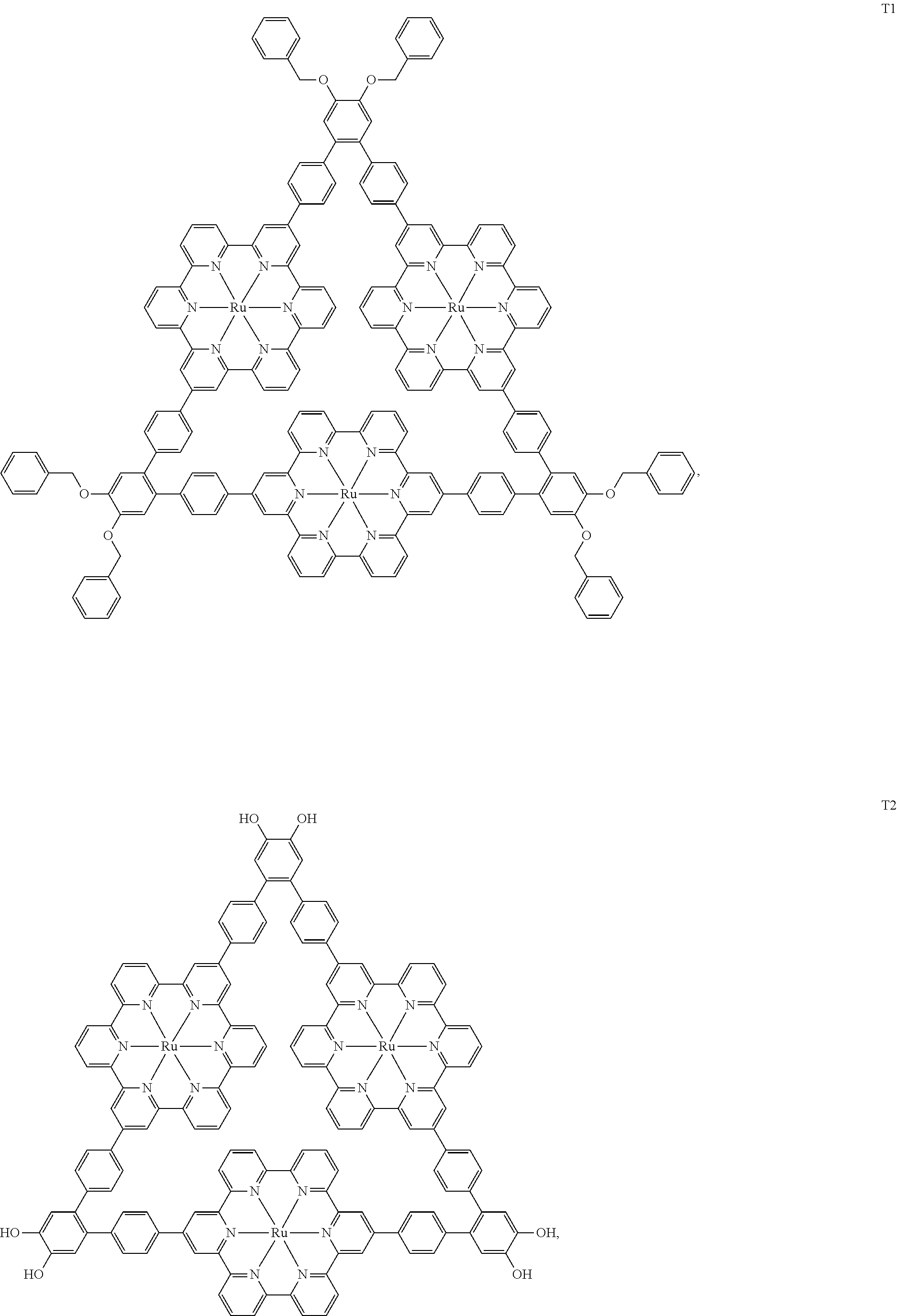

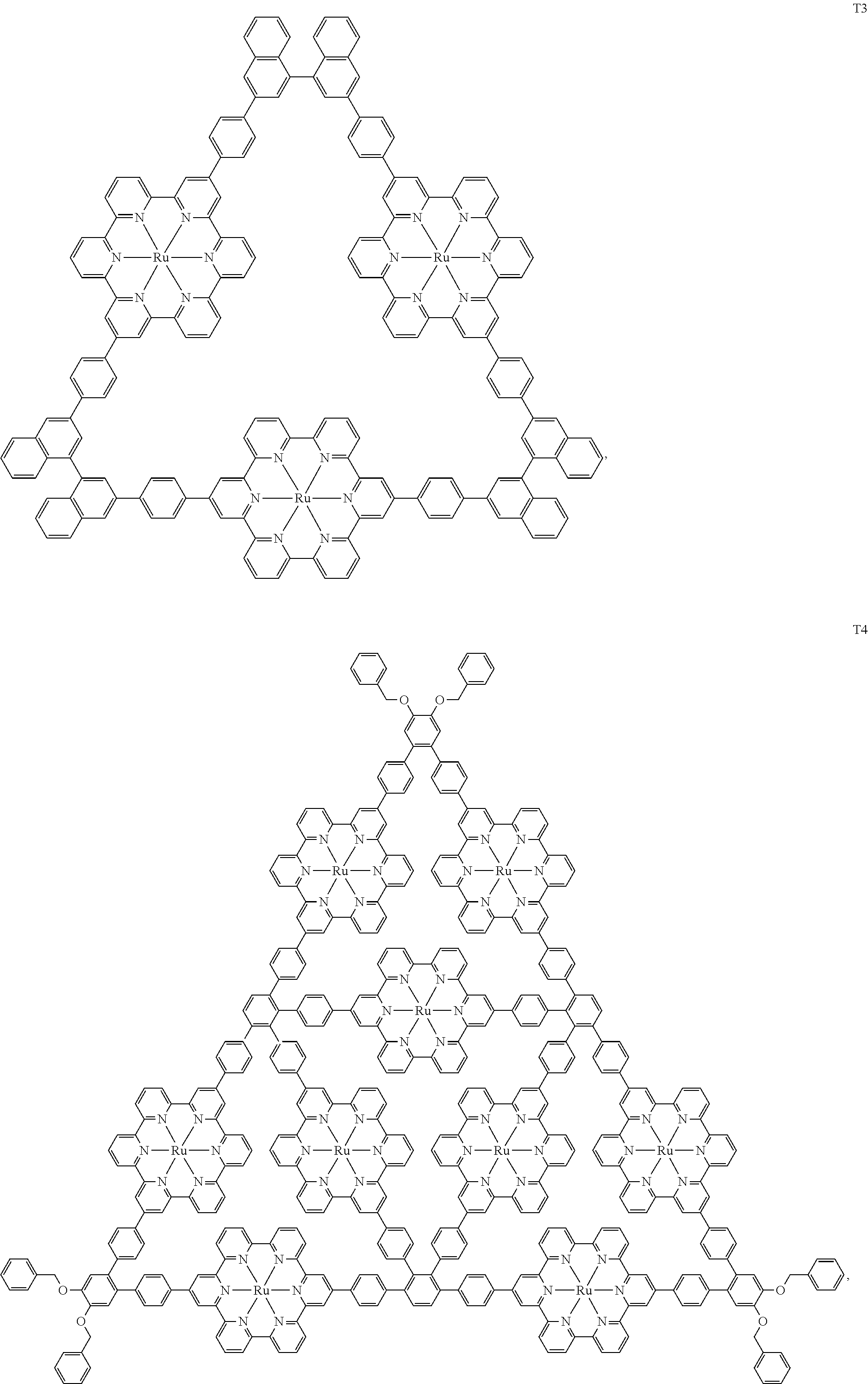

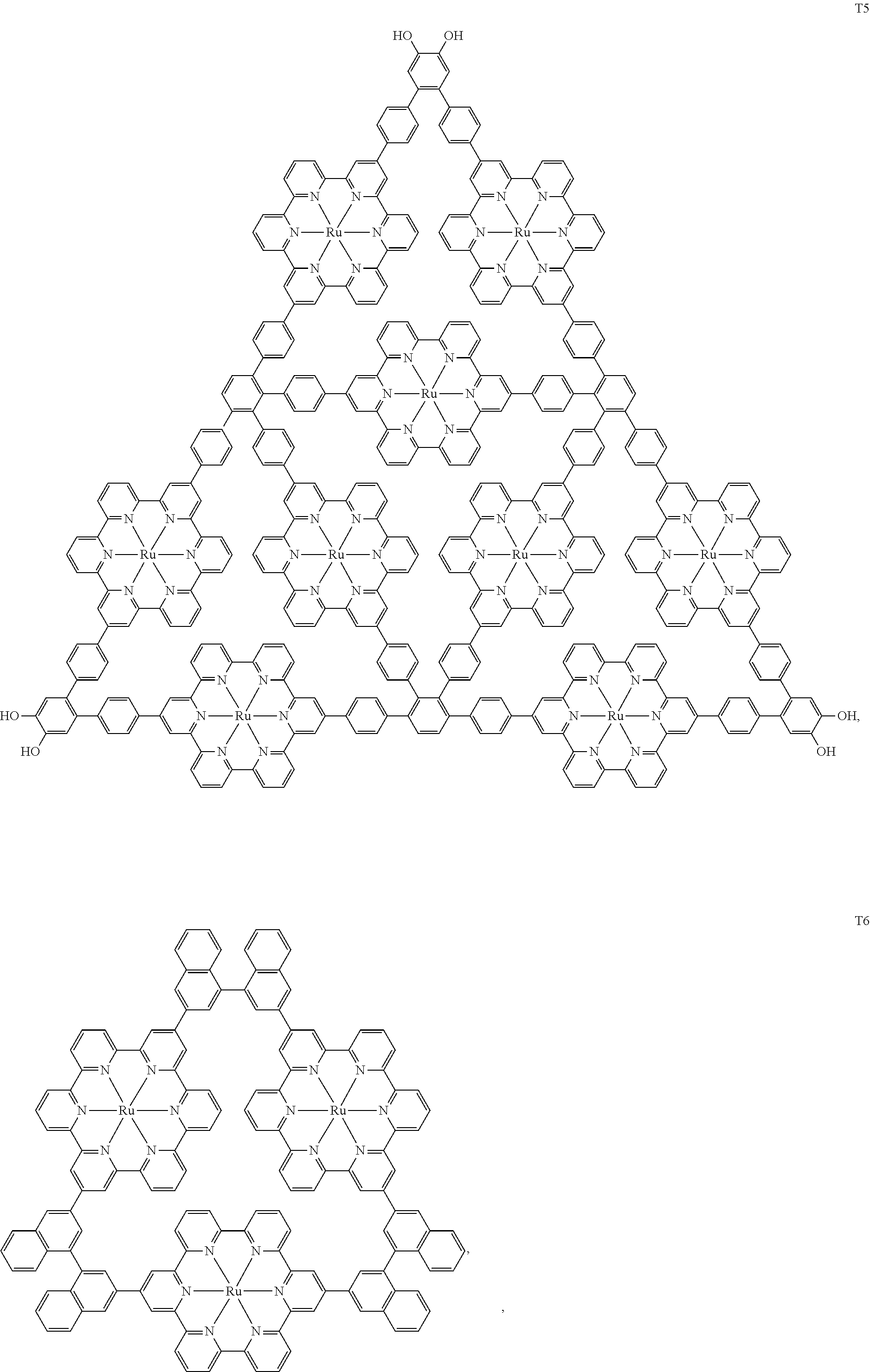

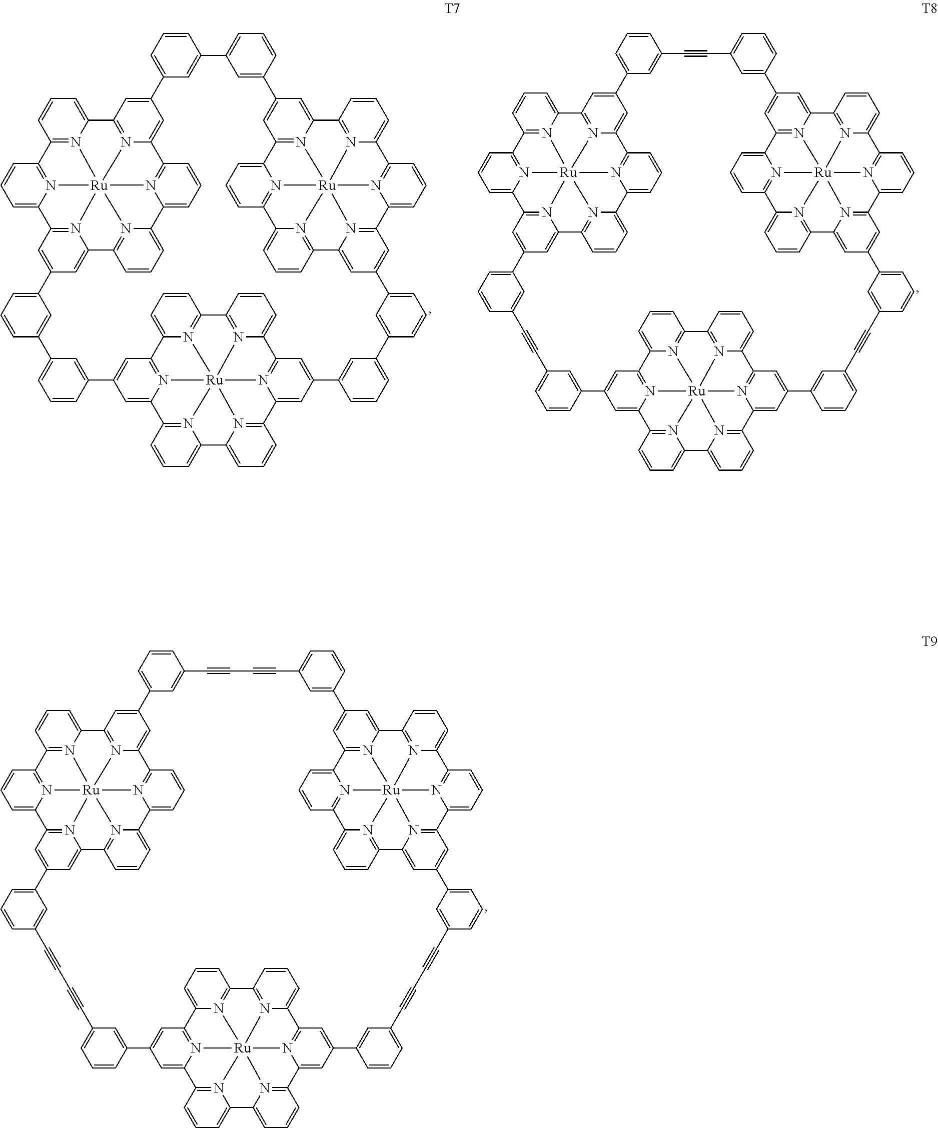

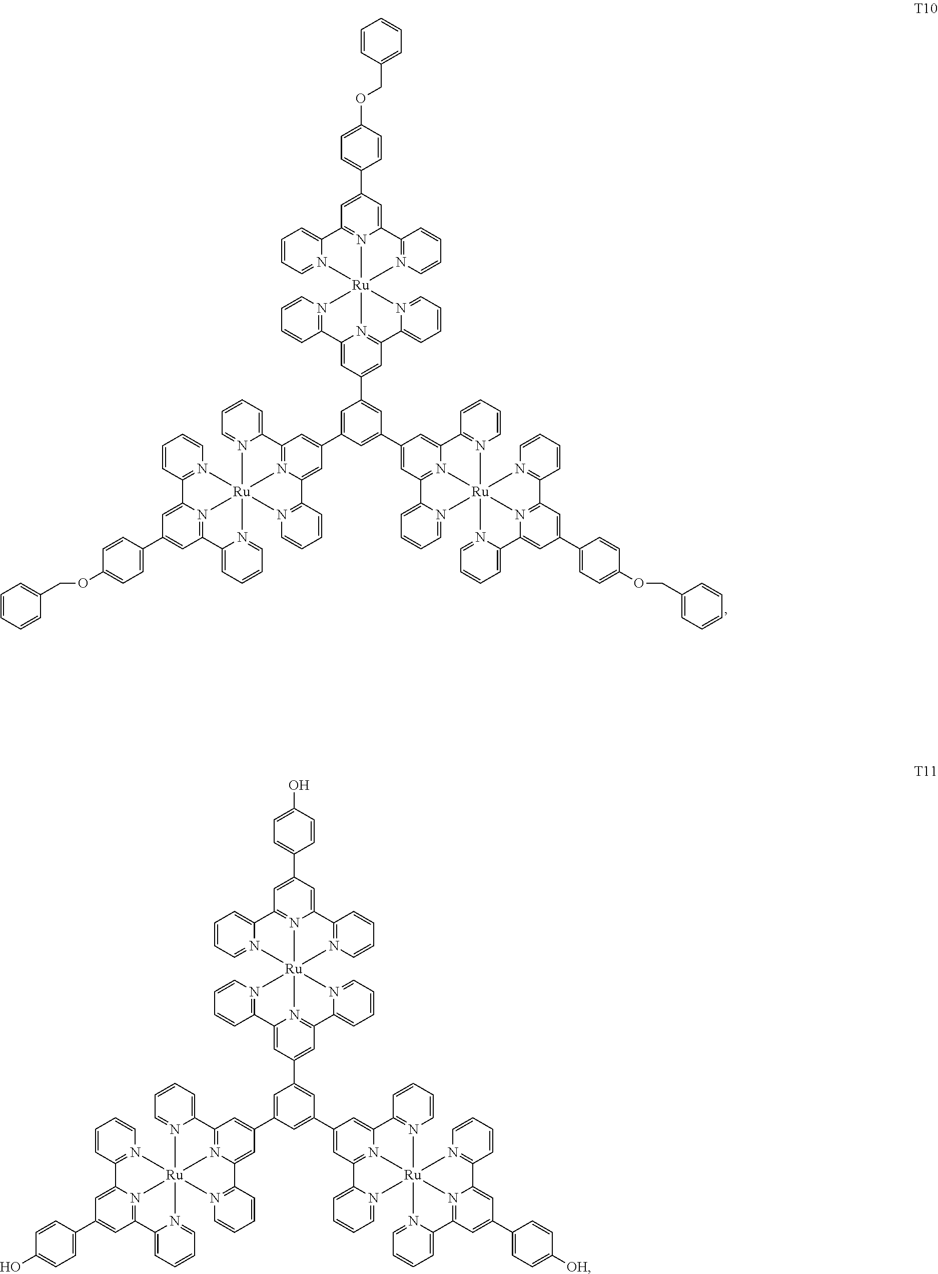

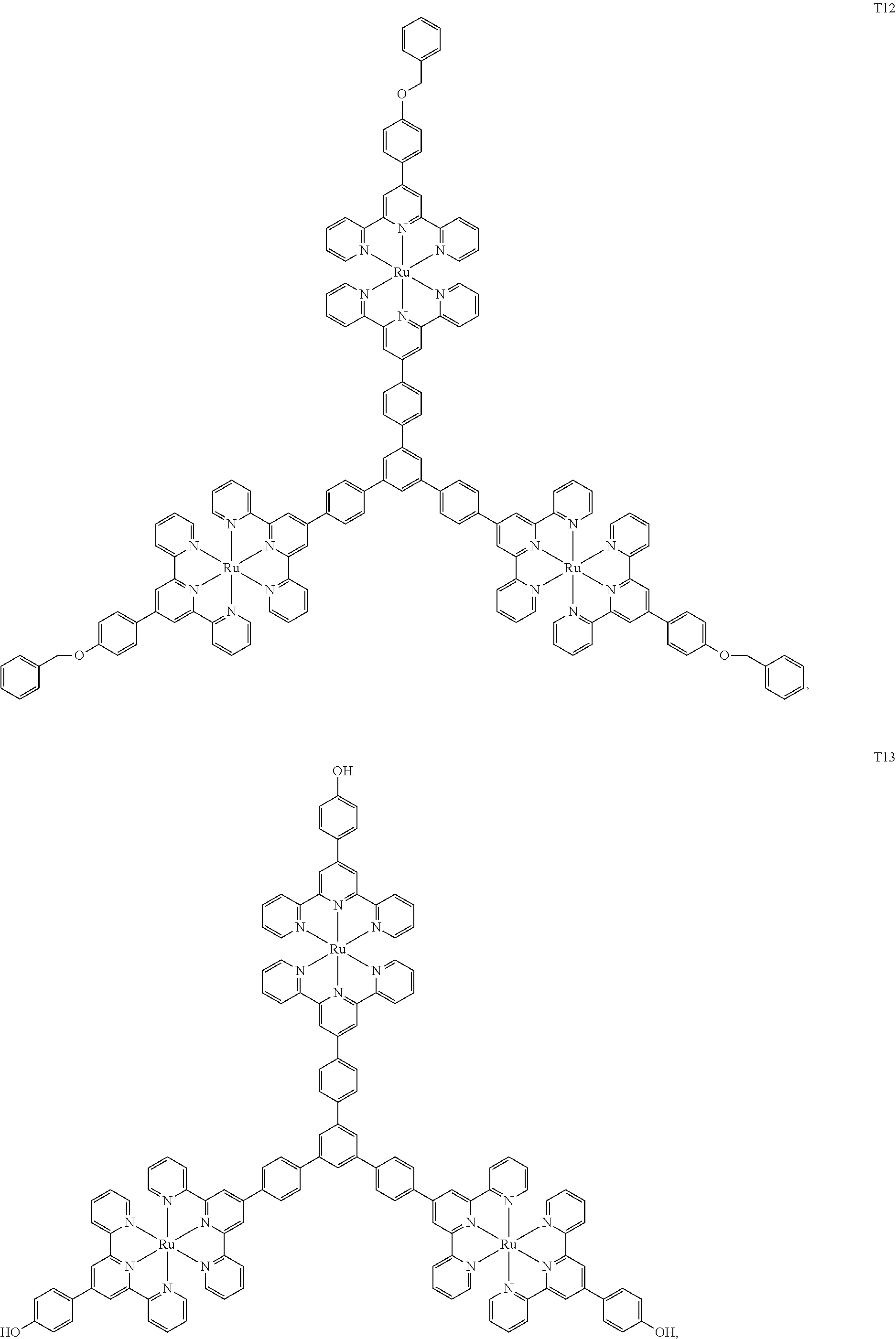

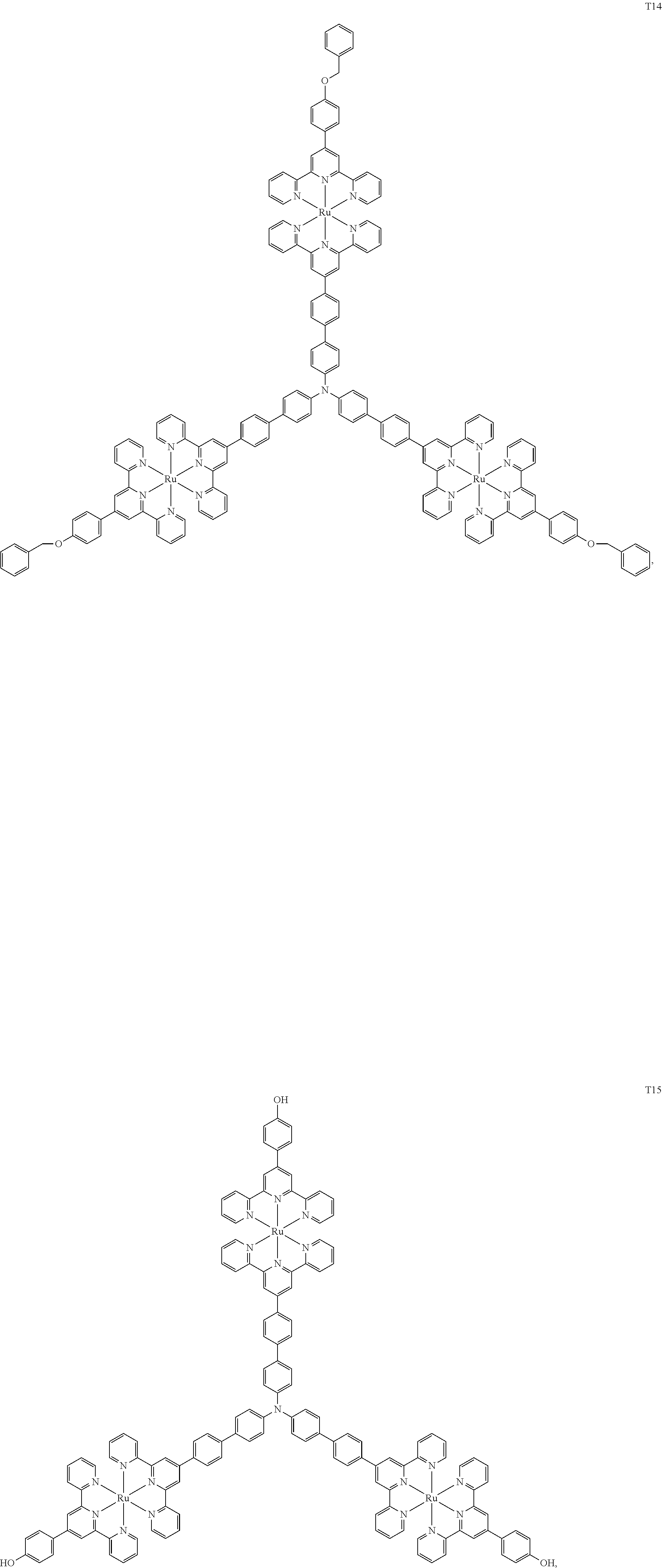

Further, the structural formula of the supramolecule compound is:

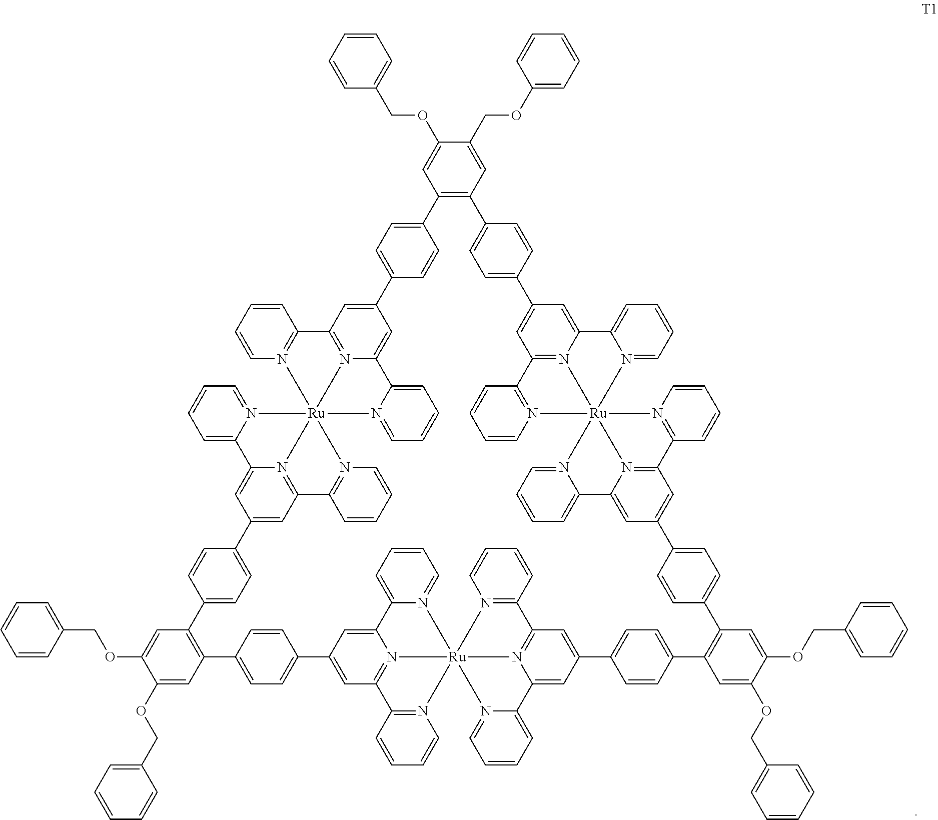

The present disclosure provides a series of supramolecule compounds with π-conjugated planar structure and are used as synthesis templates to prepare a series of novel two-dimensional rare earth oxysalts. The controllable preparation of two-dimensional rare earth oxysalts can be achieved by adding templates of the supramolecule compounds to the solvothermal precursor solution compounded by two-dimensional rare earth oxyacid materials.

For both T1 and T2, the inventors have confirmed through numerous experiments that the use of hydroxyl and benzyloxy substituted the T1 supramolecule compound and the T2 supramolecule compound can be used as synthesis templates to prepare two-dimensional rare earth oxysalts. However, supramolecule compounds with other substituents (such as methoxy-substituted supramolecule compounds) can not be used as synthesis templates to prepare two-dimensional rare earth oxysalts due to solubility and other factors.

For both T4 and T5, the inventors have confirmed through numerous experiments that the use of hydroxyl and benzyloxy substituted the T4 supramolecule compound and the T5 supramolecule compound can be used as synthesis templates to prepare two-dimensional rare earth oxysalts. However, supramolecule compounds with other substituents can not be used as synthesis templates to prepare two-dimensional rare earth oxysalts due to solubility and other factors.

In addition, the coordination bond strength formed by the Ru²⁺ cations and the terpyridine is very high, comparable to the covalent bond and much higher than that formed by the terpyridine and other metal cations (such as Fe²⁺. Zn²⁺, Cu²⁺, Cd²⁺, etc.). If part of the Ru²⁺ cations are replaced with Zn²⁺ cations, the structure of the resulting supramolecule compound is extremely unstable. The structure cannot be maintained under the solvent thermal conditions used in the present disclosure, and the supramolecule compound cannot be used as a synthesis template to prepare the two-dimensional rare earth oxysalts.

For both T7 and T8, the coordination bond strength formed by the Ru²⁺ cation and the terpyridine is very high, comparable to the covalent bond and much higher than that formed by the terpyridine and other metal cations (such as Fe²⁺, Zn²⁺, Cu²⁺, Cd²⁺, etc.). If the Ru²⁺ cations are replaced by the Fe²⁺ cations, the structure of the resulting supramolecule compound is extremely unstable, the structure no longer exists under the solvent thermal conditions used in the present disclosure, and the supramolecule compound cannot be used as a synthesis template to prepare the two-dimensional rare earth oxysalts.

For T3, T6 and T9, the coordination bond strength formed by the Ru²⁺ cations and the terpyridine is very high, comparable to the covalent bond and much higher than that formed by the terpyridine and other metal cations (such as Fe²⁺, Zn²⁺, Cu²⁺, Cd²⁺, etc.). If the Ru²⁺ cations are replaced by the Fe²⁺ cations, the structure of the resulting supramolecule compound is extremely unstable, the structure no longer exists under the solvent thermal conditions used in the present disclosure, and the supramolecule compound cannot be used as a synthesis template to prepare the two-dimensional rare earth oxysalts.

In addition, the coordination bond strength formed by the Ru²⁺ cations and the terpyridine is very high, the supramolecule compounds containing the Ru²⁺ cations cannot be prepared by a conventional one-step coordination-driven self-assembly method, so it is necessary to use the step-by-step synthesis strategy given in the embodiments of the present disclosure to compound supramolecule compounds containing the Ru²⁺ cations. The inventors have confirmed through numerous experiments that the supramolecule compounds containing the Ru²⁺ cations can not be compounded by the step-by-step synthesis strategy in the present disclosure due to the limitation of solubility and other factors using other terpyridine-based ligands (except T3, T6, T9, T7 and T8 used in the present disclosure), and can not be used as a synthesis template to prepare two-dimensional rare earth oxysalts.

For both T10 and T11, the inventors have confirmed through numerous experiments that the use of hydroxyl and benzyloxy substituted the T10 supramolecule compound and the T11 supramolecule compound can be used as synthesis templates to prepare two-dimensional rare earth oxysalts. However, supramolecule compounds with other substituents can not be used as synthesis templates to prepare two-dimensional rare earth oxysalts due to solubility and other factors.

For T12, T13, T14 and T15, the inventors have confirmed through numerous experiments that the use of hydroxyl and benzyloxy substituted the T12 supramolecule compound, the T13 supramolecule compound, the T14 supramolecule compound, and the T15 supramolecule compound can be used as synthesis templates to prepare two-dimensional rare earth oxysalts. However, supramolecule compounds with other substituents (such as methoxy, hydrogen and methyl substituted supramolecule compounds) can not be used as synthesis templates to prepare two-dimensional rare earth oxysalts due to solubility and other factors.

In addition, the solubility of the supramolecule compound containing Ru²⁺ cations is limited. In the present disclosure, the supramolecule compound containing Ru²⁺ cations is used as the synthesis template, which needs certain solubility. The inventors have confirmed through numerous experiments that supramolecule compounds containing the Ru²⁺ cations prepared by using other tritopic star-shaped terpyridine-based ligands (except those used in the present disclosure) can not be used as synthesis templates to prepare two-dimensional rare earth oxysalts due to solubility and other factors.

The present disclosure provides a method for preparing the supramolecule compound with π-conjugated planar structure, which includes the steps of: (1) providing a terpyridine-based ligand; (2) preparing the supramolecule compound with x-conjugated structure by a coordination between the terpyridine-based ligand and ruthenium cations in a ruthenium compound.

Further, the terpyridine-based ligand is selected from one or more of single-arm terpyridine-based ligands, V-type two-arm terpyridine-based ligands, tritopic star-shaped terpyridine-based ligands, and K-type four-arm terpyridine-based ligands; the ruthenium compound includes one or two of trivalent Ru compounds (RuCl₃) and divalent Ru compounds (Ru(DMSO)₄Cl₂).

Further, the specific method for preparing the supramolecule compound with π-conjugated planar structure includes the steps of:
Step 1, reacting the single-arm terpyridine-based ligand or the V-type two-arm terpyridine-based ligand with ruthenium trichloride (RuCl₃) in a mixed solvent of chloroform and methanol;
Step 2, reacting one of the V-type two-arm terpyridine-based ligand, the tritopic star-shaped terpyridine-based ligand, and the K-type four-arm terpyridine-based ligand with a product obtained from step 1 and N-ethylmorpholine in the mixed solvent of chloroform and methanol; and
Step 3, reacting a product obtained from step 2 with compound Ru(DMSO)₄Cl₂ in the mixed solvent of chloroform and methanol to obtain the supramolecule compound.

Further, in any of the above steps, the reaction temperature is 50˜90° C., and the reaction time is 10˜96 hours.

The present disclosure provides a method for preparing a two-dimensional rare earth oxysalt by using the supramolecule compound with π-conjugated structure of the present disclosure as a synthesis template, which includes the steps of:
Dissolving a rare earth ion solution, the supramolecule compound of the present disclosure, organic amine, and oxyacid source in an organic solvent to obtain a precursor solution; and
Performing a solvothermal reaction on the precursor solution at a temperature of 80˜180° C. for 2˜7 days to obtain the two-dimensional rare earth oxysalt.

The method of the present disclosure uses supramolecule compounds as synthesis templates to prepare two-dimensional rare earth oxysalts, which is similar to the biomineralization in nature. The supramolecule compounds with multiple positive (or negative) charges adsorb inorganic anions (ions) by a surface charge action, and the inorganic anions (ions) coordinate and nucleate crystallize on the surface of the supramolecule compounds. Since the supramolecule compound has a π-conjugated planar structure with a large size (not less than 3 nm), the growth of rare earth oxysalts that nucleate and crystallize on the surface of the supramolecule compound is limited in one dimension of the three-dimensional scale, then a rare earth oxysalt with a two-dimensional layered structure is formed.

Further, the rare earth ion solution is mixedly selected from the group consisting of rare earth nitrate solution, rare earth acetate solution, rare earth triflate solution, rare earth tetrafluoroborate solution, and rare earth halide solution; a concentration of the rare earth salt in the rare earth ion solution is 1˜100 mg/mL; the solvent used in the rare earth ion solution is selected from the group consisting of water, methanol, ethanol, n-propanol, isopropanol, n-butanol, isobutanol, tert-butanol, and benzyl alcohol, etc.

Further, the organic amine is selected from the group consisting of N,N-dimethylformamide, N,N-dimethylacetamide, N,N-diethylformamide, 1,3-Dimethyl-3,4,5,6-tetrahydro-2(1H)-pyrimidinone, 1,3-Dimethyl-2-Imidazolidinone, trimethylamine, triethylamine, pyridine, derivative of pyridine containing substituents, pyrazine, derivative of pyrazine containing substituents, piperazine, derivative of piperazine containing substituents, imidazole, derivative of imidazole containing substituents, triazole, tetrazole, and quaternary ammonium salt, etc.

Further, the oxyacid source is selected from the group consisting of sulfuric acid, ammonium sulfate, ammonium bisulfate, alkali metal sulfate, alkaline earth metal sulfate, phosphoric acid, ammonium phosphate, diamine hydrogen phosphate, ammonium dihydrogen phosphate, phosphoric acid ester, phosphorous acid, ammonium phosphite, phosphite, diethyl phosphite, tetraisopropyl titanate, tetra-n-butyl titanate, boric acid, boric acid ester, dimethyl sulfoxide, and sulfolane, etc.

Further, based on the precursor solution, a concentration of the organic amine is 1˜200 mg/mL, a concentration of the oxyacid source is 1˜200 mg/mL, and a concentration of the supramolecule compound with π-conjugated structure is 1˜100 mg/mL.

The present disclosure provides a series of two-dimensional rare earth oxysalts, which are prepared by the method in the present disclosure.

Further, the two-dimensional rare earth oxysalt is selected from one or more of two-dimensional rare earth sulfate, two-dimensional rare earth selenate, two-dimensional rare earth phosphoric acid, two-dimensional rare earth phosphite, two-dimensional rare earth chromate, and two-dimensional rare earth arsenate, etc.

The present disclosure has the following beneficial effects:

(1) A series of two-dimensional rare earth oxysalts with the same structure or different structures can be effectively and controllably prepared by the template-based synthesis strategy based on the supramolecule compounds in the present disclosure.

(2) By the template-based synthesis strategy based on the supramolecule compounds in the present disclosure, it is possible to use the same synthesis scheme to prepare two-dimensional rare earth oxysalts containing all rare earth elements including lanthanide (La—Lu), scandium (Sc), and yttrium (Y). The synthesis method is universal. The template-based synthesis strategy based on supramolecule compounds in the present disclosure can prepare two-dimensional rare earth oxysalts with a single structure and containing one or more of rare earth elements, which is more conducive to the regulation of their properties.

(3) The obtained two-dimensional rare earth oxysalts have high crystallinity, and a clear crystal structure can be resolved by single crystal X-ray diffraction.

(4) By the template-based synthesis strategy based on supramolecule compounds in the present disclosure, two-dimensional rare earth oxyacid materials can be prepared predictably by selecting different oxyacid sources and organic amine types (amides, tertiary amines, and quaternary ammonium salts, etc.). At the same time, by selecting the types and ratios of organic amines and oxyacid sources, the structures of two-dimensional rare earth oxysalts can be more precisely regulated, and the structural diversity of two-dimensional rare earth oxysalts can be realized, which is conducive to studying accurate structure-activity relationships of rare earth oxysalts.

(5) The two-dimensional rare earth oxysalts obtained by the template-based synthesis strategy based on supramolecule compounds have good stability.

### BRIEF DESCRIPTION OF THE DRAWINGS

FIG. 1 is the 1H NMR spectrum of the compound 3.

FIG. 2 is the 1H NMR spectrum of the compound 5.

FIG. 3 is the 1H NMR spectrum of the supramolecule compound T1.

FIG. 4 is a flow chat for preparing a two-dimensional rare earth oxysalt by using a supramolecule compound with a π-conjugated planar structure as a synthesis template.

FIG. 5 is a crystal structure diagram of the two-dimensional rare earth oxysalt structure C1, (a) is a ball-and-stick model, (b) is a simplified polyhedron model.

FIG. 6 is a crystal structure diagram of the two-dimensional rare earth oxysalt structure C2, (a) is a ball-and-stick model, (b) is a simplified polyhedral model.

FIG. 7 is a crystal structure diagram of the two-dimensional rare earth oxysalt structure C3, (a) is a ball-and-stick model, (b) is a simplified polyhedron model.

FIG. 8 is a crystal structure diagram of the two-dimensional rare earth oxysalt structure C4 (a) is a ball-and-stick model, (b) is a simplified polyhedron model.

FIG. 9 is a crystal structure diagram of the two-dimensional rare earth oxysalt structure C5, (a) is a ball-and-stick model, (b) is a simplified polyhedron model.

### DETAILED DESCRIPTION OF EMBODIMENTS

The present disclosure provides a supramolecule compound with a π-conjugated planar structure, a two-dimensional rare earth oxysalt and a preparation method therefor. In order to make the purposes, technical schemes, and effects of the present disclosure more clear and definite, the present disclosure is further described in detailed below. It should be understood that the specific embodiments described herein are only used to explain the present disclosure, not to limit the present disclosure.

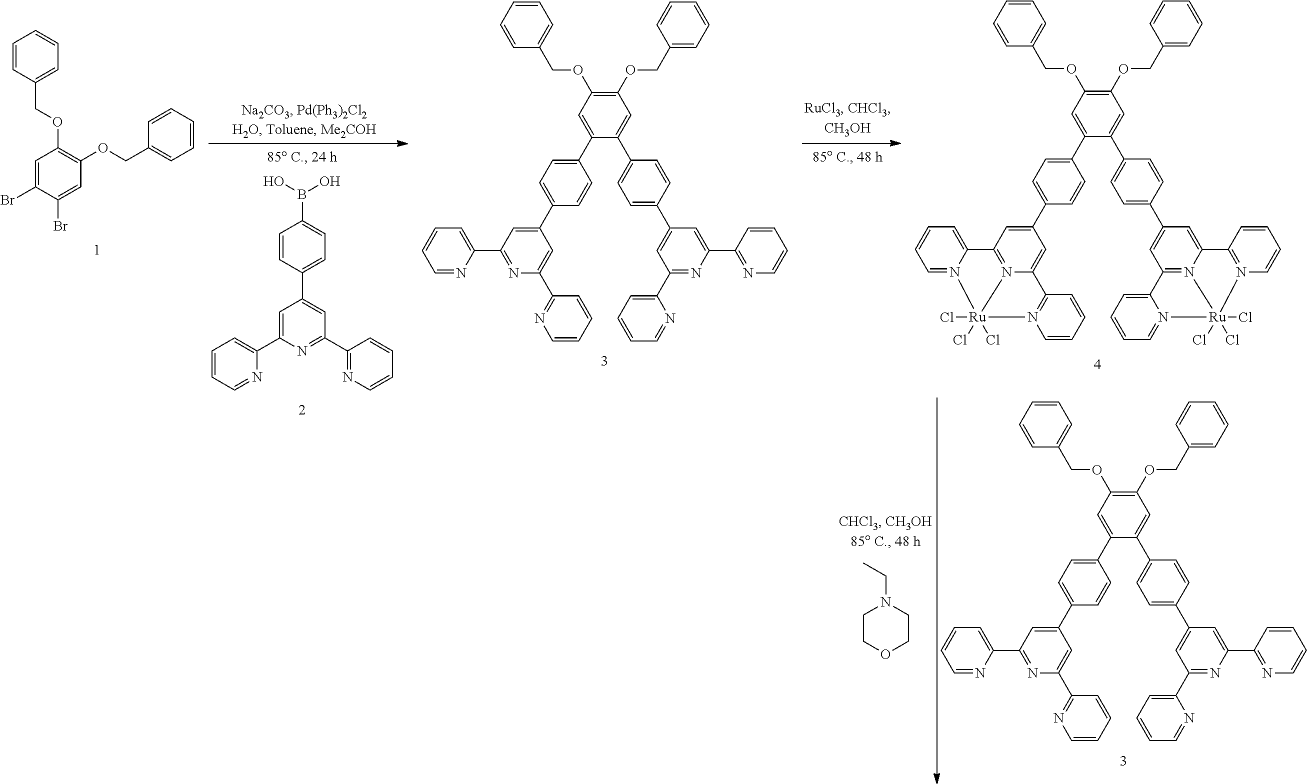

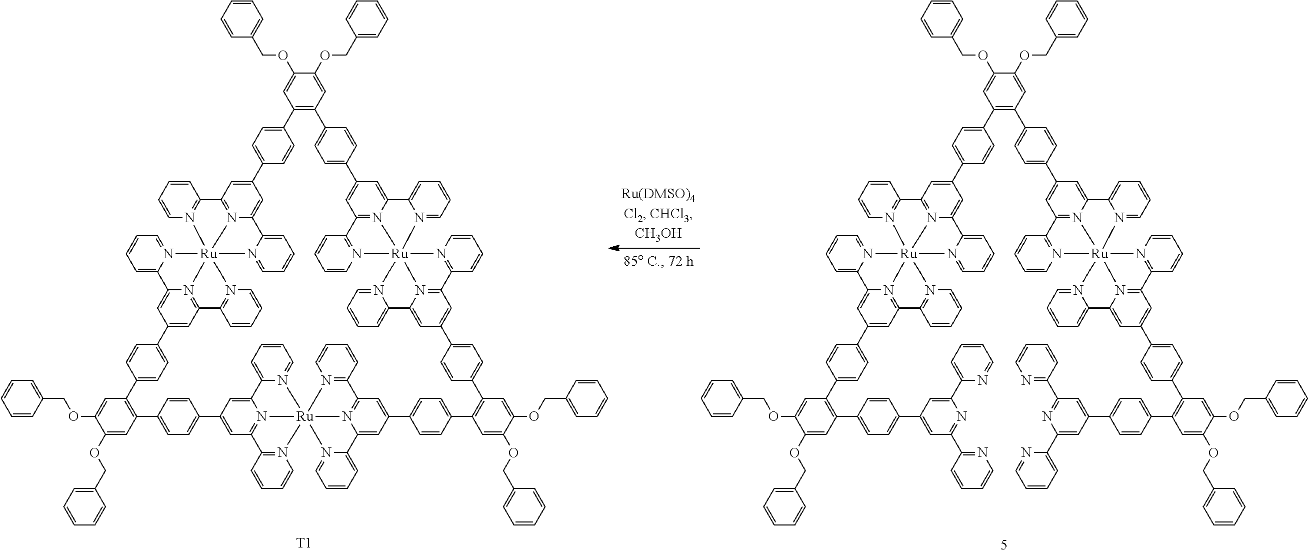

Preparing compound 3: compound 1 (0.5 mmol, 2.23 g), compound 2 (1.25 mmol, 4.42 g), Pd(PPh₃)₂Cl₂ (0.35 mmol, 0.25 g), and sodium carbonate (60.0 mmol, 6.32 g) were added to a 250 mL Schlenk bottle. The Schlenk bottle were then subjected to three times of nitrogen replacements. Toluene (60 mL), water (30 mL), and tert-butanol (10 mL) were added under nitrogen atmosphere, mixed thoroughly, and then stirred at 85° C. for 24 hours. After cooling to room temperature, the mixture was washed and extracted with dichloromethane and water, and an organic phase was collected and dried over anhydrous sodium sulfate. After removing the solvent, the obtained mixture is refluxed with methanol for 4 hours, filtered, washed, and dried to obtain 3.96 g of the compound 3 with a yield of 88%. ¹H NMR (500 MHz, CDCl₃) δ (ppm), 8.63˜8.72 (s, 12H, H^{3′,5′}, H^{6,6″}, H^{3,3″}), 7.79˜7.87 (s, 8H, H^{4,4″}, H_{w}), 7.53˜7.53 (s, 4H, H^{b}), 7.23˜7.74 (s, 14H, H^{c}, H^{d}, H^{5,5″}, H^{v}), 7.11 (s, 2H, H^{u}), 5.28 (s, 2H, H^{a}). The ¹H NMR spectrum of the compound 3 is shown in FIG. 1.

Preparing compound 4: the compound 3 (1.2 mmol, 1.02 g), ruthenium trichloride (1.8 mmol, 0.78 g), methanol (400 mL), and dichloromethane (400 mL) were added to a 1000 mL flask, mixed thoroughly, and then stirred at 65° C. for 48 hours. After cooling to room temperature, the obtained mixture was filtered, washed with water and methanol sequentially, and dried to obtain 1.55 g of the compound 4 with a yield of 97%.

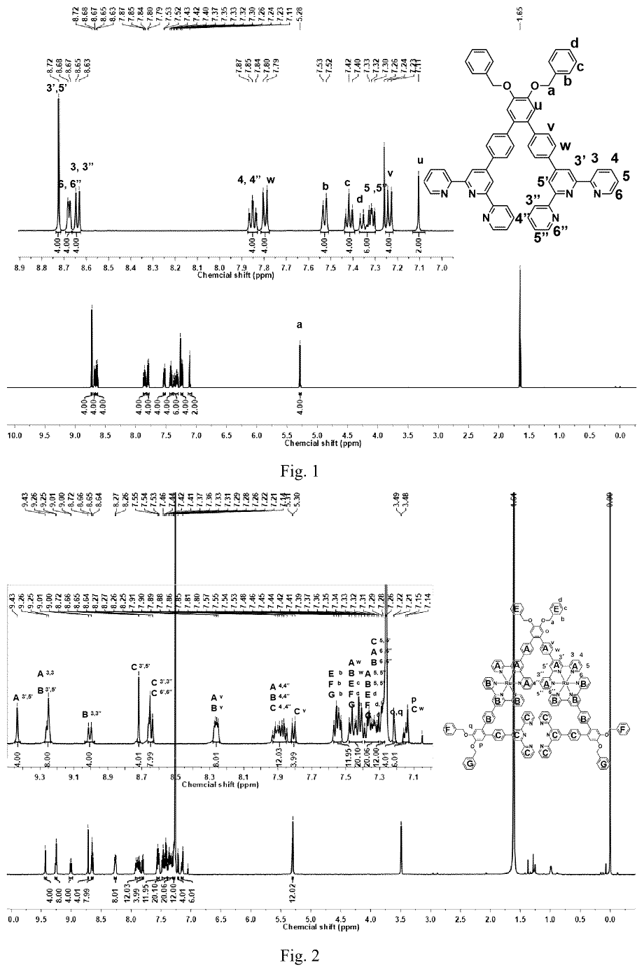

Preparing compound 5: the compound 4 (0.56 mmol, 0.76 g), the compound 3 (1.1 mmol, 2.02 g), N-ethylmorpholine (3.5 mL), methanol (300 mL), and chloroform (300 mL) were added in a 1000 mL flask, mixed thoroughly, and then stirred at 65° C. for 48 hours. After cooling to room temperature, the solvent was removed to obtain a crude product. The crude product was separated and purified by a neutral aluminum oxide chromatographic column, gradient eluted with dichloromethane and a dichloromethane solution containing 0.5%-2.5% methanol, and finally dried to obtain 0.69 g of the compound 5 with a yield of 44%. ¹H NMR (500 MHz, CDCl₃) δ (ppm), 9.43 (s, 4H, H^{3′,5′}), 9.26˜9.24 (s, 8H, HA^{B′,5′}, HA^{3,3″}), 9.01˜8.99 (m, 4H, HB^{3,3″}), 8.71˜8.63 (s, 12H, HC^{3′,5′}, HC^{6,6″}, HC^{3,3″}), 8.27˜8.25 (m, 8H, HA^{v}, HB^{v}), 7.91˜7.80 (m, 16H, HA^{4,4″}, HB^{4,4″}, HC^{4,4″}, HC^{v}), 7.53˜7.52 (s, 12H, HE^{b}, HF^{b}, HD^{b}), 7.47˜7.28 (s, 48H, HE^{c}, HF^{c}, HG^{c}, HE^{d}, HF^{d}, HG^{d}, HA^{5,5″}, HB^{5,5″}, HC^{5,5″}, HA^{w}, HB^{w}), 7.22˜7.21 (s, 4H, H^{o}, H^{q}), 7.15˜7.14 (s, 4H, Hₒ, HC^{w}). The ¹H NMR spectrum of the compound 5 is shown in FIG. 2.

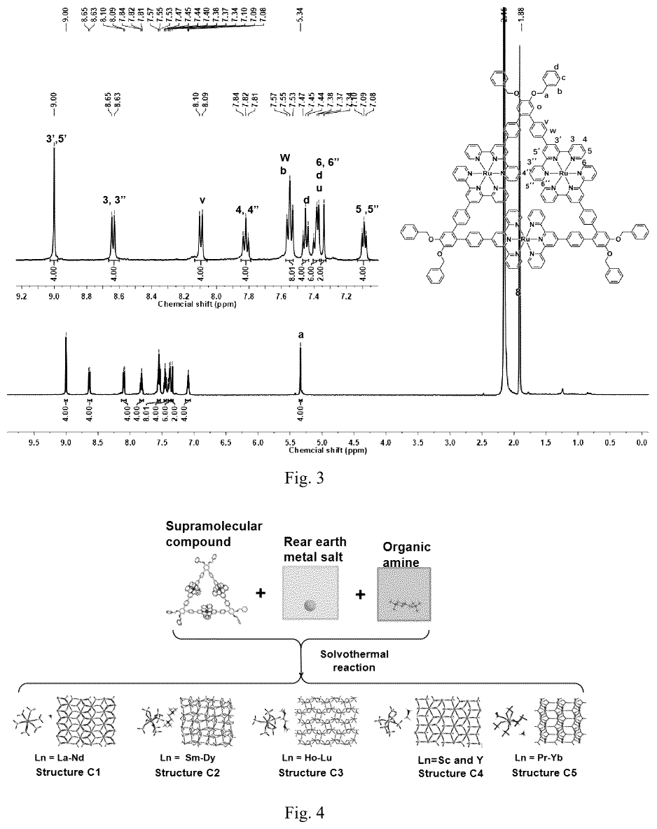

Preparing supramolecule compound T1: the compound 5 (0.1 mmol, 0.31 g), Ru(DMSO)₄Cl₂ (0.12 mmol, 0.060 g), methanol (400 mL), and chloroform (400 mL) were added to a 1000 mL flask, mixed thoroughly, and then stirred at 65° C. for 72 hours. After cooling to room temperature, the solvent was removed, the obtained mixture was washed with water and methanol, and finally dried to obtain 0.34 g of the compound T1 with a yield of 91%. ¹H NMR (500 MHz, CDCl₃) δ (ppm), 9.00 (s, 4H, H^{3′,5′}), 8.65˜8.63 (s, 4H, H^{6,6″}), 8.09˜810 (s, 4H, H^{w}), 7.81˜7.84 (s, 4H, H^{4,4″}), 7.34˜7.57 (s, 20H, H^{v}, H^{b}), 7.23˜7.74 (s, 14H, H^{c}, H^{d}, H^{6,6″}, H^{u}), 7.10˜7.08 (s, 4H, H^{5,5″}), 5.34 (s, 4H, H^{a}). The ¹H NMR spectrum of the supramolecule compound T1 is shown in FIG. 3.

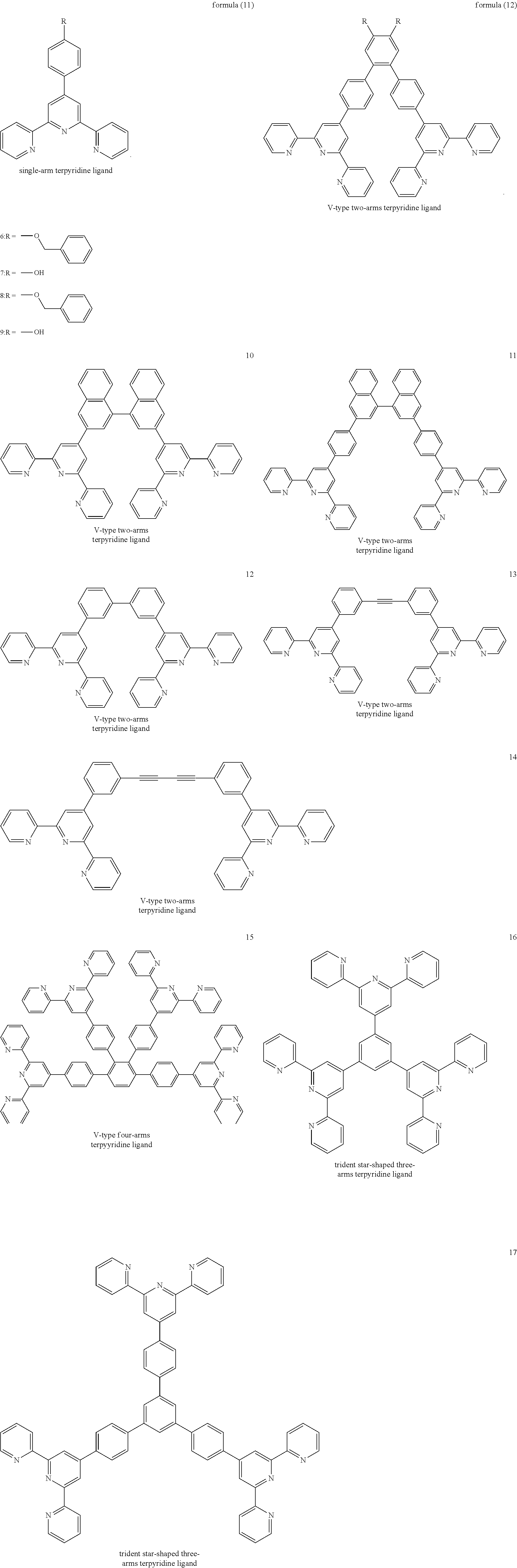

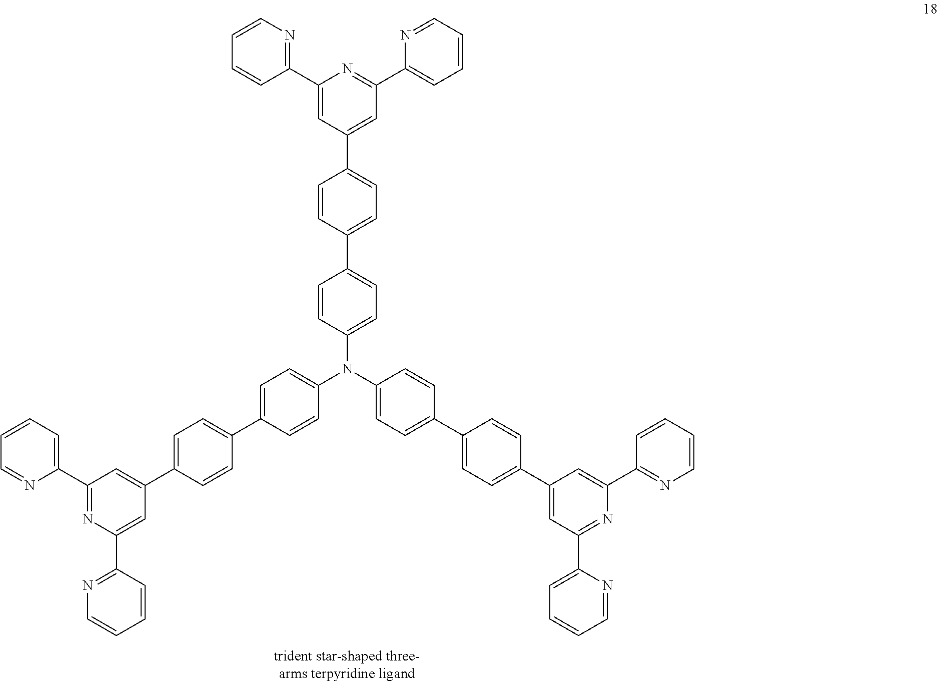 [SMILES: c1ccc(-c2cc(-c3ccc(-c4ccc(N(c5ccc(-c6ccc(-c7cc(-c8ccccn8)nc(-c8ccccn8)c7)cc6)cc5)c5ccc(-c6ccc(-c7cc(-c8ccccn8)nc(-c8ccccn8)c7)cc6)cc5)cc4)cc3)cc(-c3ccccn3)n2)nc1]

In addition, the preparation methods of the compound T2 in the formula (1), the compound T3 in the formula (2), the compound T6 in the formula (4), the compound T7 in the formula (5), the compound T8 in the formula (6), and the compound T9 in the formula (7) are basically the same as the preparation method of the above compound T1, difference is that the V-type two-arm terpyridine-based ligands of different structures are used to replace the compound 3 in the above method.

The preparation methods of compounds T10 and T11 in formula (8), compounds T12 and T13 in formula (9), compounds T14 and T15 in formula (10) are also basically the same as the preparation method of the above compound T1, difference is that the single-arm terpyridine-based ligand and the tritopic star-shaped terpyridine-based ligand are used to replace the compound 3 in the above method.

The preparation methods of compounds T4 and T5 in formula (3) are also basically the same as the preparation method of the above compound T1, difference is that the V-type two-arm terpyridine-based ligand and the K-type four-arm terpyridine-based ligand are used to replace the compound in the above method.

As shown in FIG. 4, the following is a method for preparing two-dimensional rare earth oxysalts with different structures using a supramolecule compounds as a synthesis template, as follows:

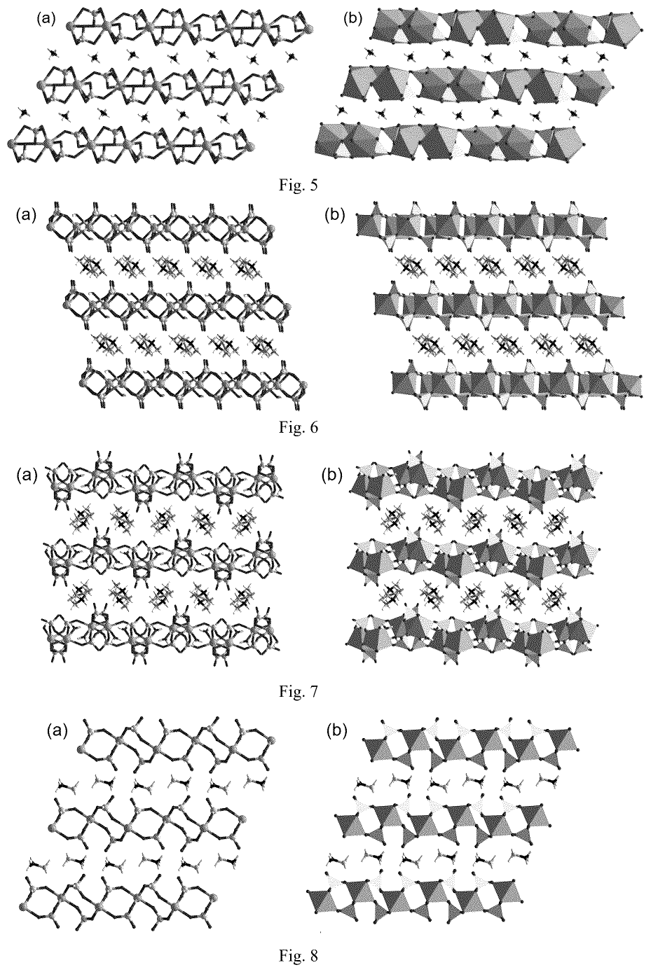

Synthesis of crystal structure C1: Ln(NO₃)₃·xH₂O (0.15 g, 0.3 mmol, Ln=La−Nd) was dissolved in a 1.5 mL mixed solvent of methanol and water (volume ratio was 2:1) to prepare a rare earth ion solution. Then, the rare earth ion solution (0.5 mL), the supramolecule compound T1 (10 mg) in formula (1), 1,3-dimethyl-2-imidazolidinone (1.0 mL), and dimethyl sulfoxide (1.0 mL) were added into a 5 mL polytetrafluoroethylene reactor to obtain a precursor solution. The precursor solution was reacted at 160° C. for 3 days. After cooling to room temperature, 25 mg of colorless or light yellow crystal C1 (Ln=La−Nd) was obtained with a yield of 71%. The crystal structure of C1 obtained by single crystal X-ray diffraction test is shown in FIG. 5. The crystal structure is (NH₄)Ln(SO₄)₂ two-dimensional rare earth oxysalt, where Ln=La−Nd.

Synthesis of crystal structure C2: Ln(NO₃)₃·xH₂O (0.15 g, 0.3 mmol, Ln=Sm−Dy) was dissolved in a 1.5 mL mixed solvent of methanol and water (volume ratio was 2:1) to prepare a rare earth ion solution. Then, the rare earth ion solution (0.5 mL), the supramolecule compound T2 (10 mg) in formula (1), 1,3-dimethyl-2-imidazolidinone (1.0 mL), and dimethyl sulfoxide (1.0 mL) were added into a 5 mL polytetrafluoroethylene reactor to obtain a precursor solution. The precursor solution was reacted at 160° C. for 3 days. After cooling to room temperature, 23 mg of colorless or light yellow crystal C2 (Ln=Sm−Dy) was obtained with a yield of 59%. The crystal structure C2 obtained by single crystal X-ray diffraction test is shown in FIG. 6. The crystal structure is (DEDA)Ln₂(SO₄)₄(H₂O)₂ two-dimensional rare earth oxysalt, where DEDA is tetramethyl ethylenediamine, Ln=Sm−Dy.

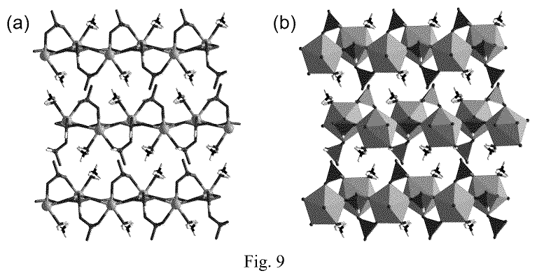

Synthesis of crystal structure C3: Ln(NO₃)₃·xH₂O (0.15 g, 0.3 mmol, Ln=Ho−Lu) was dissolved in a 1.5 mL mixed solvent of methanol and water (volume ratio was 2:1) to prepare a rare earth ion solution. Then, the rare earth ion solution (0.5 mL), the supramolecule compound T11 (10 mg) in formula (8), 1,3-dimethyl-2-imidazolidinone (1.0 mL), and dimethyl sulfoxide (1.0 mL) were added into a 5 mL polytetrafluoroethylene reactor to obtain a precursor solution. The precursor solution was reacted at 160° C. for 3 days. After cooling to room temperature, 21 mg of colorless or light yellow crystal C3 (Ln=Ho−Lu) was obtained with a yield of 55%. The crystal structure C3 obtained by single crystal X-ray diffraction test is shown in FIG. 7. The crystal structure is (DEDA)Ln₂(SO₄)₄(H₂O)₂ two-dimensional rare earth oxysalt, where DEDA is tetramethyl ethylenediamine, Ln=Ho−Lu.

Synthesis of crystal structure C4: Ln(NO₃)₃·xH₂O (0.15 g, 0.3 mmol, Ln=Sc, Y) was dissolved in 1.5 mL water to prepare a rare earth ion solution. Then, the rare earth ion solution (0.5 mL), the supramolecule compound T1 (10 mg) in formula (1), 1,3-dimethyl-2-imidazolidinone (1.0 mL), and dimethyl sulfoxide (1.0 mL) were added into a 5 mL polytetrafluoroethylene reactor to obtain a precursor solution. The precursor solution was reacted at 160° C. for 3 days. After cooling to room temperature, 20 mg of colorless or light yellow crystal C4 (Ln=Sc, Y) was obtained with a yield of 53%. The crystal structure C4 obtained by single crystal X-ray diffraction test is shown in FIG. 8. The crystal structure is (CH₆N)Ln(SO₄)₂ two-dimensional rare earth oxysalt, where Ln=Sc, Y.

Synthesis of crystal structure C5: Ln(NO₃)₃·xH₂O (0.15 g, 0.3 mmol, Ln=Pr−Yb) was dissolved in 6 mL methanol to prepare a rare earth ion solution. The rare earth ion solution (1.0 mL), the supramolecule compound T15 (10 mg) in formula (10), N,N-dimethylformamide (1.0 mL), and diethyl phosphite (0.5 mL) were added into a 5 mL polytetrafluoroethylene reactor to obtain a precursor solution. The precursor solution was reacted at 100° C. for 5 days. After cooling to room temperature, 30 mg of colorless or light yellow crystal C5 (Ln=Pr−Yb) was obtained with a yield of 65%. The crystal structure C5 obtained by single crystal X-ray diffraction test is shown in FIG. 9. The crystal structure is (NH₄)Ln(HPO₄)₂(H₂O) two-dimensional rare earth oxysalt, where Ln=Pr−Yb.

In addition, it has been proved by experiments that two-dimensional rare earth oxysalts with different structures can also be prepared by using other supramolecule compounds as synthesis templates. The preparation method is the same as the above method, and a brief description is given here.

Crystal structure C1 was synthesized with the compound T3 in formula (2): the synthesis method is the same as the preparation method of crystal structure C1 with the compound T1 above, the difference is that the supramolecule compound T1 in formula (1) was replaced by the supramolecule compound T3 in formula (2).

Crystal structure C3 was synthesized with the compound T4 in formula (3): the preparation method is the same as the preparation method of crystal structure C3 with the compound T1 above, the difference is that the supramolecule compound T1 in formula (1) was replaced by the supramolecule compound T4 in formula (3).

Crystal structure C1 was synthesized with the compound T6 in formula (4): the preparation method is the same as the preparation method of crystal structure C1 with the compound T1 above, the difference is that the supramolecule compound T1 in formula (1) was replaced by the supramolecule compound T6 in formula (4).

Crystal structure C2 was synthesized with the compound T7 in formula (5): the preparation method is the same as the preparation method of crystal structure C2 with the compound T1 above, the difference is that the supramolecule compound T1 in formula (1) was replaced by the supramolecule compound T7 in formula (5).

Crystal structure C5 was synthesized with the compound T8 in formula (6): the preparation method is the same as the preparation method of crystal structure C5 with the compound T1 above, the difference is that the supramolecule compound T1 in formula (1) was replaced by the supramolecule compound T8 in formula (6).

Crystal structure C4 was synthesized with the compound T9 in formula (7): the preparation method is the same as the preparation method of crystal structure C4 with the compound T1 above, the difference is that the supramolecule compound T1 in formula (1) was replaced by the supramolecule compound T9 in formula (7).

Crystal structure C1 was synthesized with the compound T10 in formula (8): the preparation method is the same as the preparation method of crystal structure C1 with the compound T1 above, the difference is that the supramolecule compound T1 in formula (1) was replaced by the supramolecule compound T10 in formula (8).

Crystal structure C4 was synthesized with the compound T12 in formula (9): the preparation method is the same as the preparation method of crystal structure C4 with the compound T1 above, the difference is that the supramolecule compound T1 in formula (1) was replaced by the supramolecule compound T12 in formula (9).

Crystal structure C5 was synthesized with the compound T14 in formula (10): the preparation method is the same as the preparation method of crystal structure C5 with the compound T1 above, the difference is that the supramolecule compound T1 in formula (1) was replaced by the supramolecule compound T14 in formula (10).

In summary, the present disclosure provides a new method for preparing two-dimensional rare earth oxysalts based on π-conjugated planar structure supramolecule compounds as synthesis templates, and designs and synthesizes a series of π-conjugated planar structure supramolecule compound templates, two-dimensional rare earth sulfates, two-dimensional rare earth selenates, two-dimensional rare earth phosphates, two-dimensional rare earth phosphites, two-dimensional rare earth chromates, two-dimensional rare earth arsenates, and other new two-dimensional rare earth oxygen salt materials. By selecting different supramolecule compound templates, different oxyacid sources and organic amine types, two-dimensional rare earth oxysalts with different structures can be effectively and controllably prepared. At the same time, the method is applicable to all rare earth elements of lanthanide (La—Lu) and scandium (Sc) and yttrium (Y). In addition, the method can prepare two-dimensional rare earth oxysalts with a single structure and containing one or more rare earth elements, which is more conducive to the regulation of the properties of such materials. This strategy is expected to realize the structural diversity of two-dimensional rare earth oxysalts, which in turn facilitates the study of the accurate structure-activity relationship of two-dimensional rare earth oxysalts.

It should be understood that the application of the present disclosure is not limited to the above embodiments, and those skilled in the art can make improvements or transformations according to the above descriptions, and all these improvements and transformations should belong to the protection scope of the appended claims of the present disclosure.

1-9. (canceled)

10. A supramolecule compound with π-conjugated planar structure, wherein a structural formula of the supramolecule compound is selected from the group consisting of T1, T2, T3, T4, T5, T6, T7, T8, T9, T10, T11, T12, T13, T14, and T15:

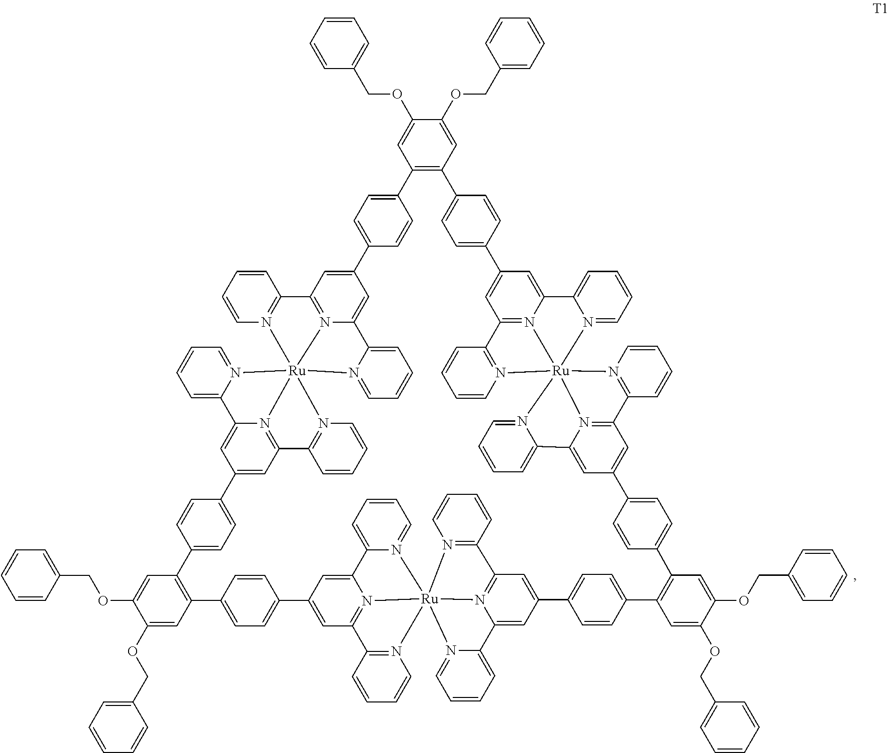

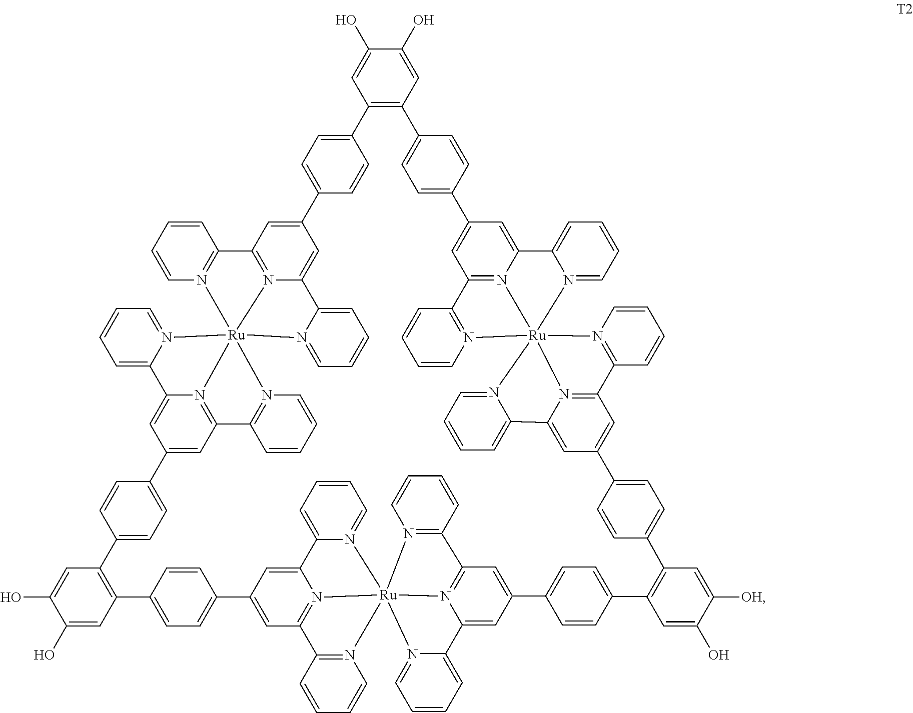

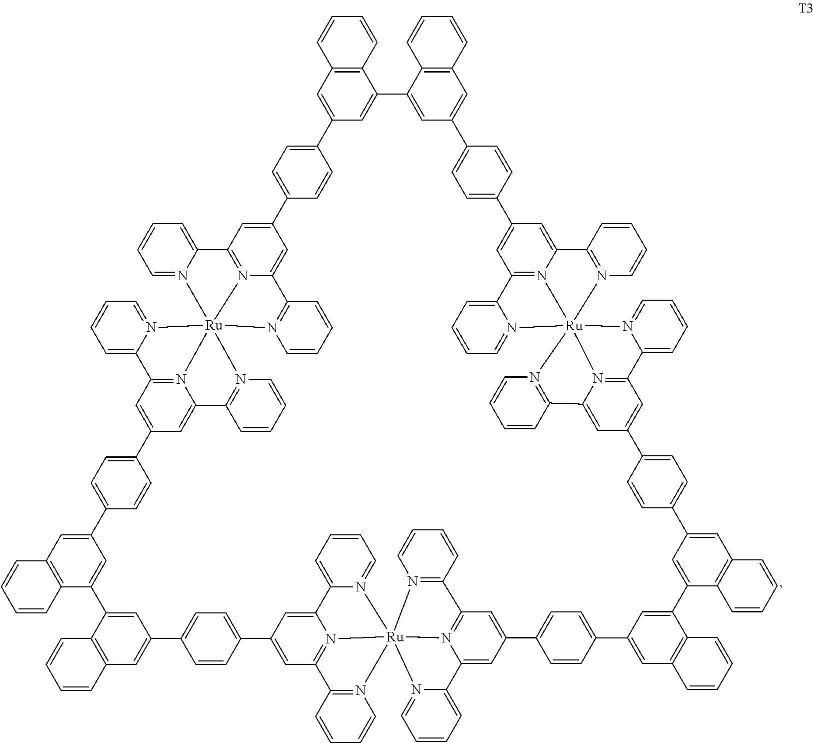

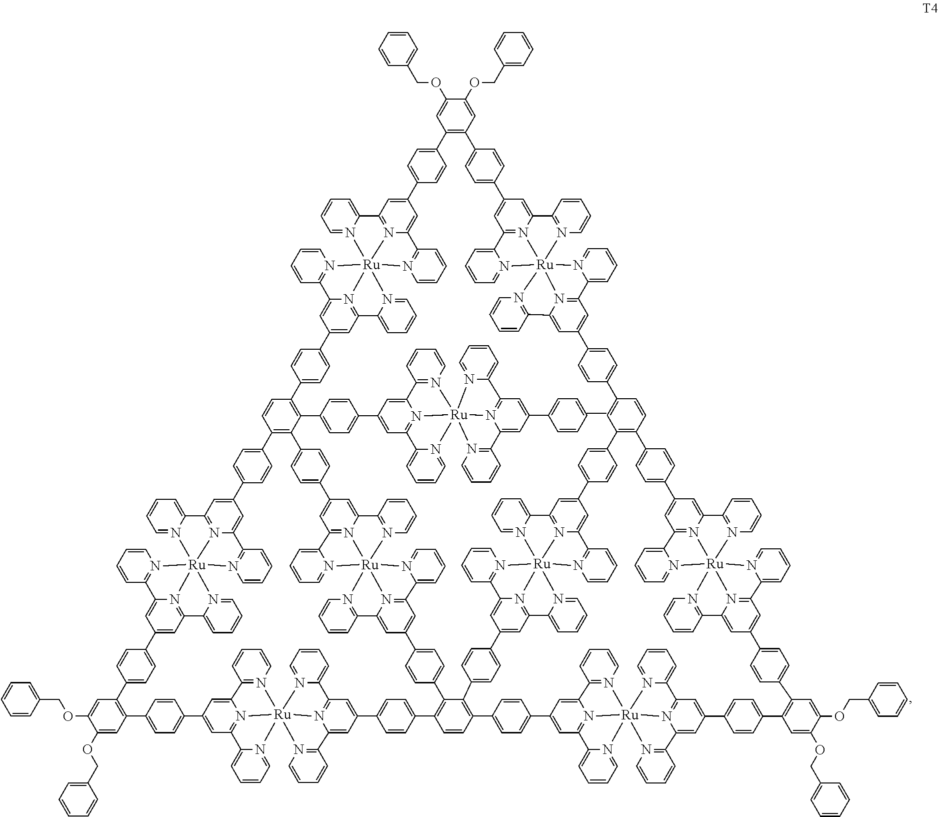

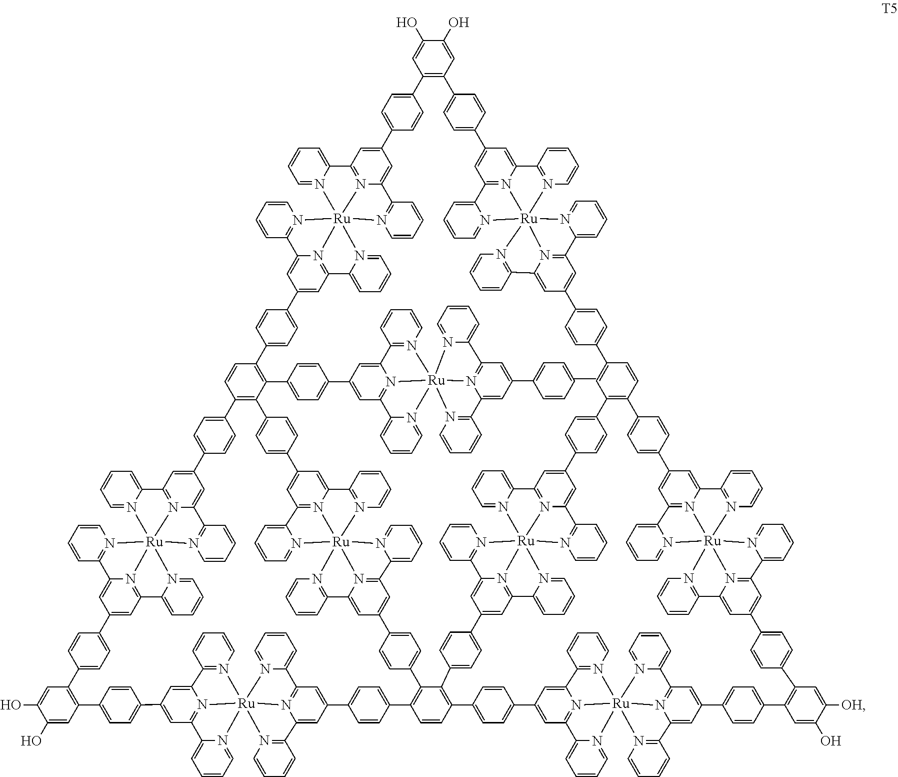

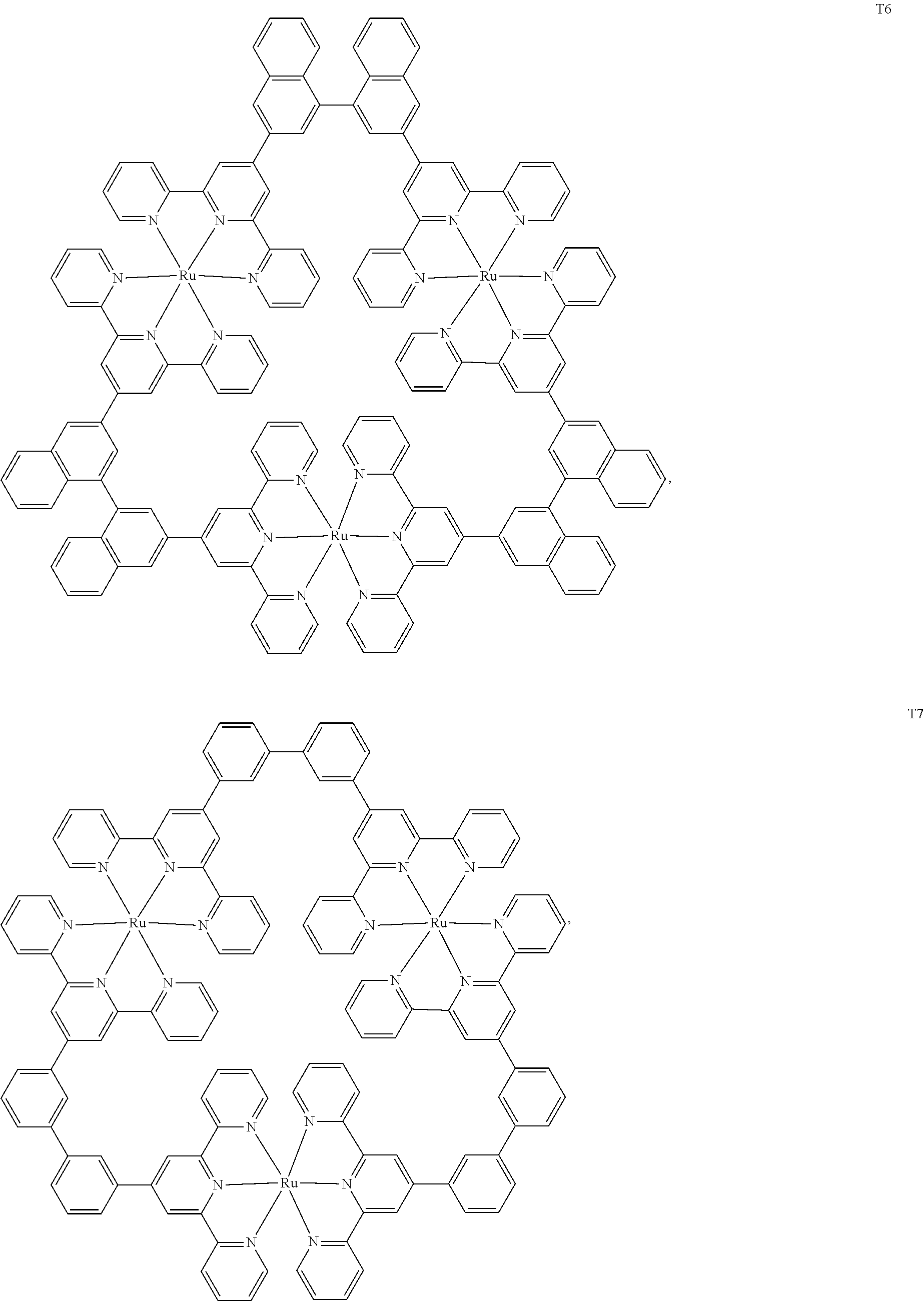

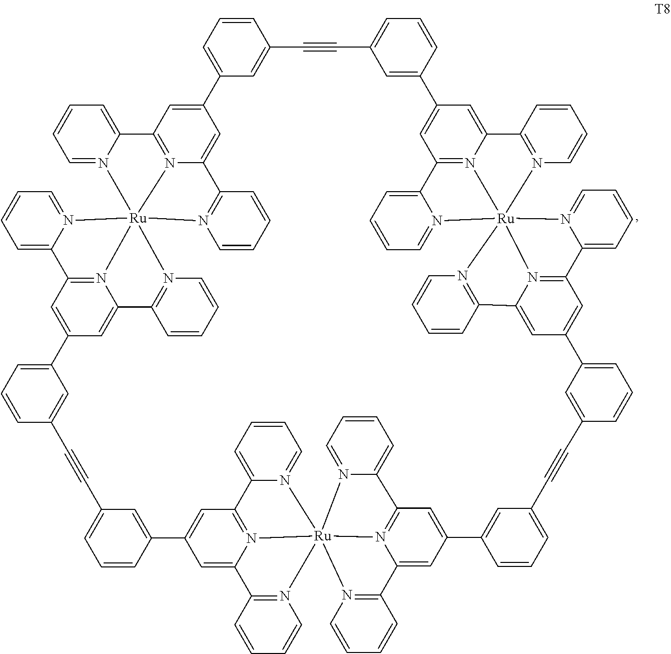

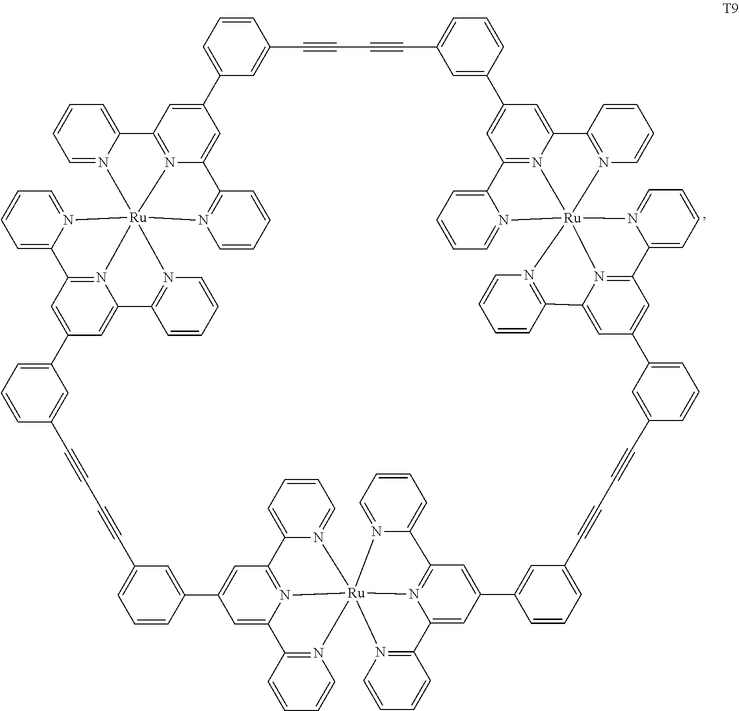

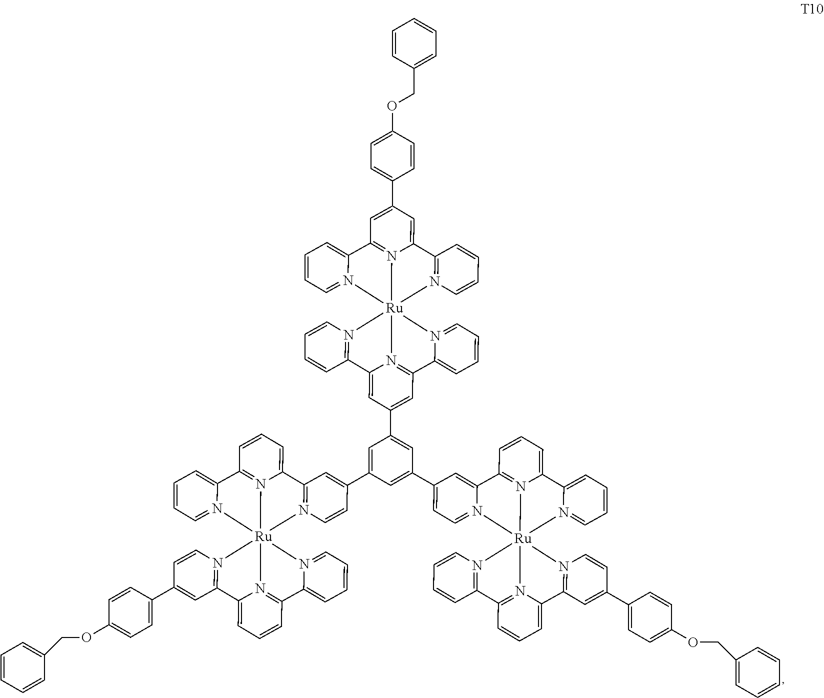

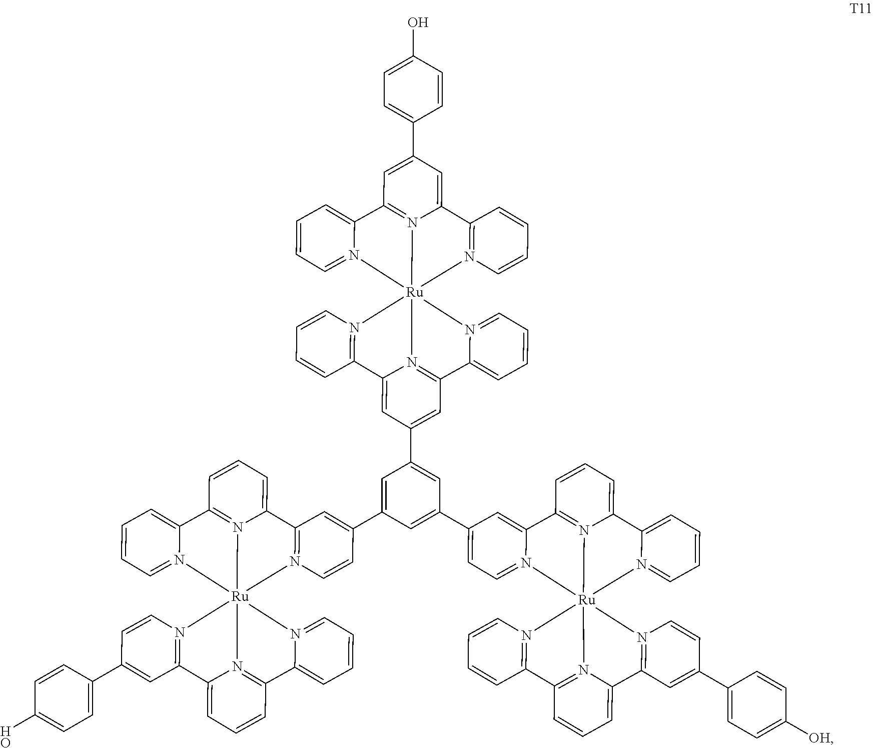

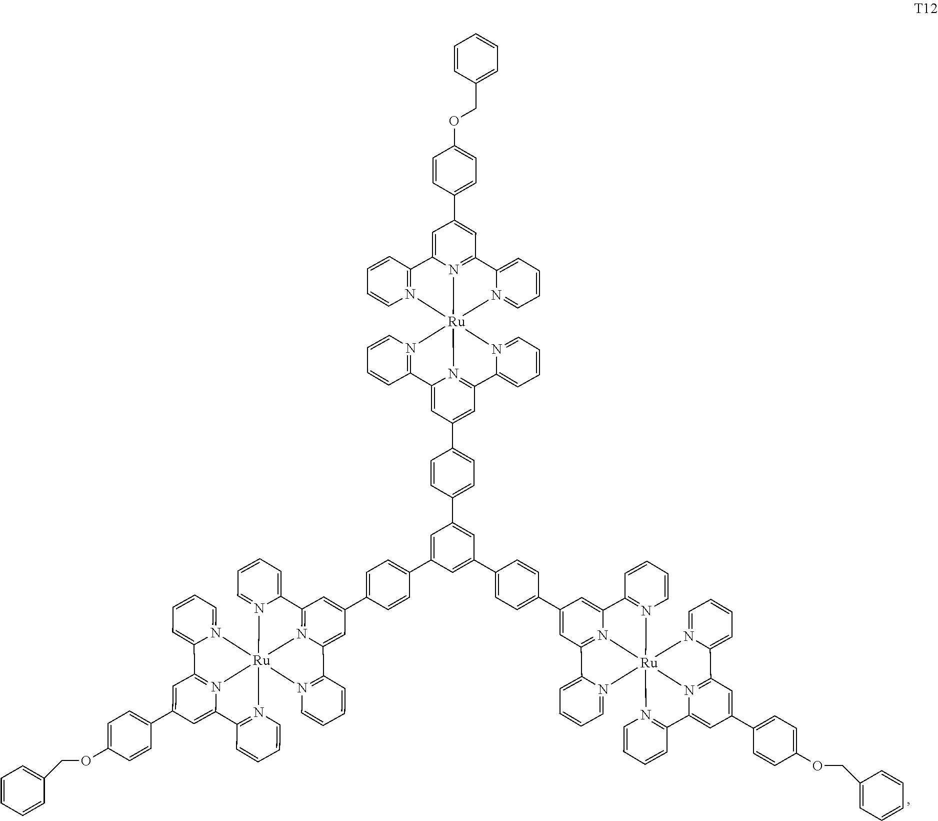

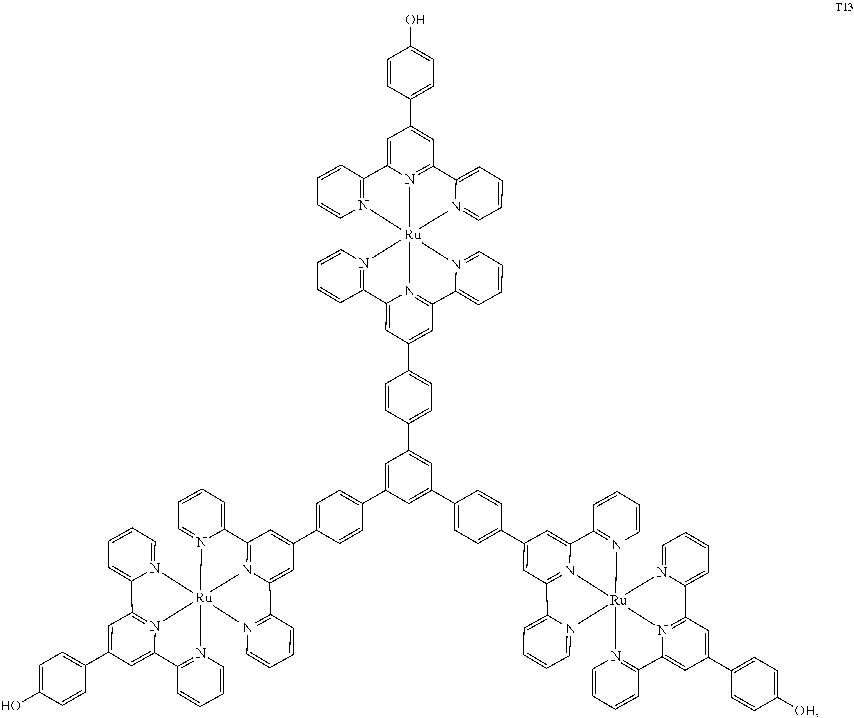

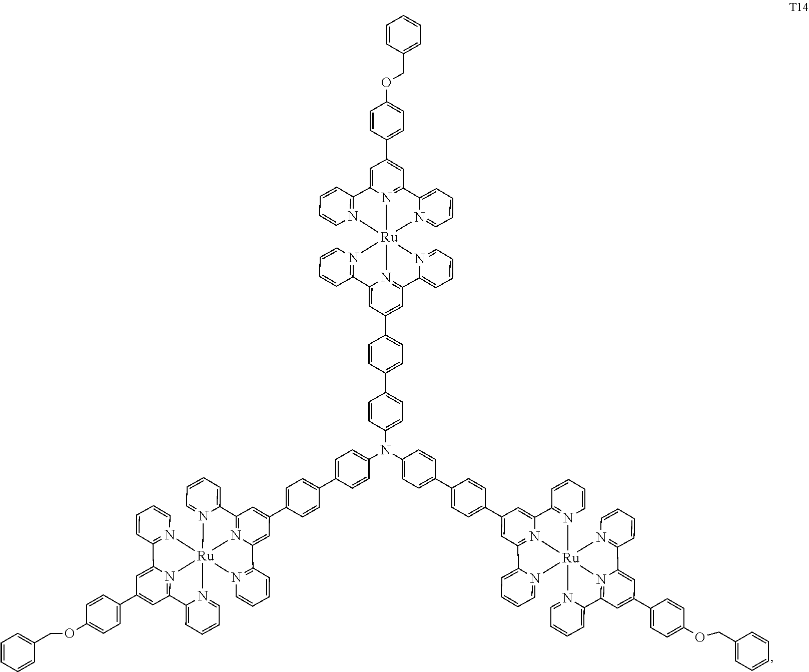

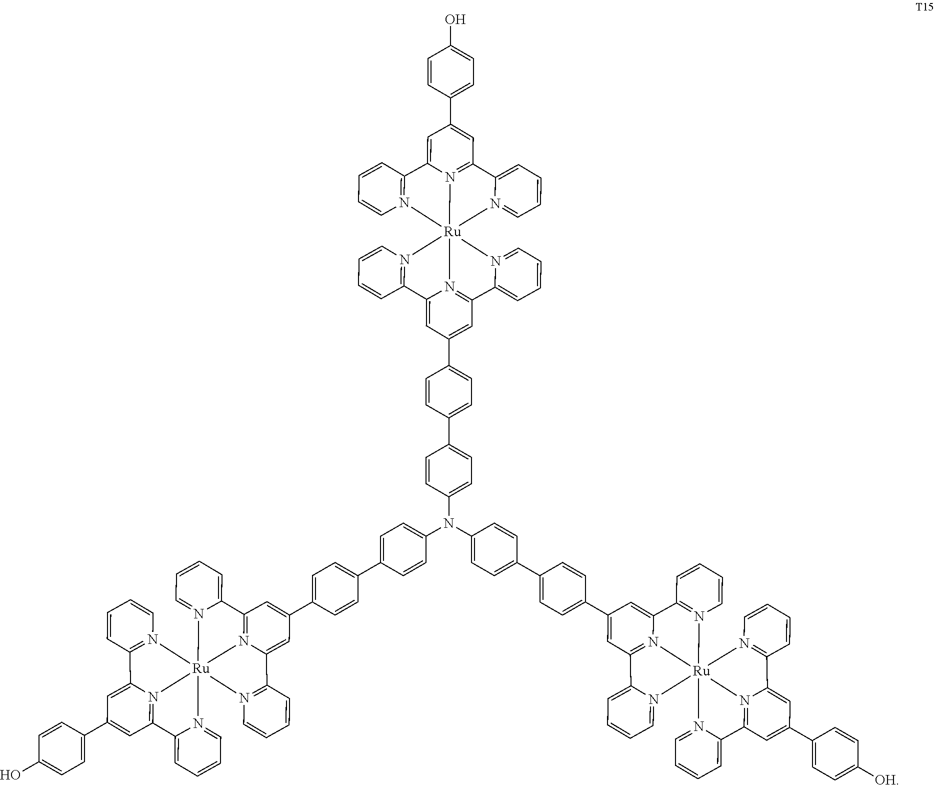

11. The supramolecule compound with π-conjugated planar structure of claim 10, wherein the structural formula of the supramolecule compound is:

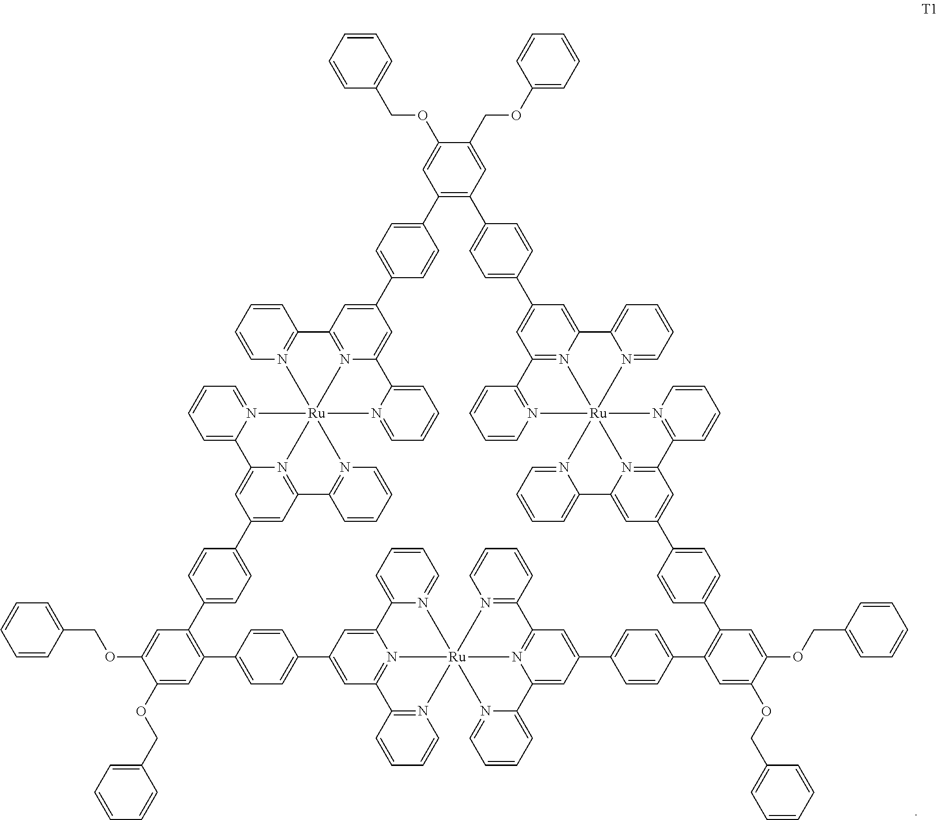

12. A method for preparing the supramolecule compound with π-conjugated planar structure of claim 10, comprising steps of:
providing a terpyridine-based ligand; and
preparing the supramolecule compound with π-conjugated structure by coordination between the terpyridine-based ligand and ruthenium cations in a ruthenium compound;
wherein the terpyridine-based ligand is selected from the group consisting of a single-arm terpyridine-based ligand, a V-type two-arm terpyridine-based ligand, a tritopic star-shaped terpyridine-based ligand, and a K-type four-arm terpyridine-based ligand; and
the ruthenium compound comprises one or two of a trivalent Ru compound and a divalent Ru compound.

13. The method of claim 12, further comprising steps of:
step 1, reacting the single-arm terpyridine-based ligand or the V-type two-arm terpyridine-based ligand with ruthenium trichloride in a mixed solvent of chloroform and methanol;
step 2, reacting one of the V-type two-arm terpyridine-based ligand, the tritopic star-shaped terpyridine-based ligand, and the K-type four-arm terpyridine-based ligand with a product obtained from step 1 and N-ethylmorpholine in the mixed solvent of chloroform and methanol; and
step 3, reacting a product obtained from step 2 with compound (Ru(DMSO)₄Cl₂) in the mixed solvent of chloroform and methanol to obtain the supramolecule compound.

14. A method for preparing a two-dimensional rare earth oxysalt by using the supramolecule compound with π-conjugated structure of claim 10 as a synthesis template, the method comprises steps of:
dissolving a rare earth ion solution, the supramolecule compound of claim 10, organic amine, and oxyacid source in an organic solvent to obtain a precursor solution; and
performing a solvothermal reaction on the precursor solution at a temperature of 80˜180° C. for 2˜7 days to obtain the two-dimensional rare earth oxysalt.

15. The method of claim 14, wherein the rare earth ion solution is mixedly selected from the group consisting of rare earth nitrate solution, rare earth acetate solution, rare earth triflate solution, rare earth tetrafluoroborate solution, and rare earth halide solution;
a concentration of the rare earth salt in the rare earth ion solution is 1˜100 mg/mL;
a solvent used in the rare earth ion solution is selected from the group consisting of water, methanol, ethanol, n-propanol, isopropanol, n-butanol, isobutanol, tert-butanol, and benzyl alcohol.

16. The method of claim 14, wherein the organic amine is selected from the group consisting of N,N-dimethylformamide, N,N-dimethylacetamide, N,N-diethylformamide, 1,3-Dimethyl-3,4,5,6-tetrahydro-2(1H)-pyrimidinone, 1,3-Dimethyl-2-Imidazolidinone, trimethylamine, triethylamine, pyridine, derivative of pyridine containing substituents, pyrazine, derivative of pyrazine containing substituents, piperazine, derivative of piperazine containing substituents, imidazole, derivative of imidazole containing substituents, triazole, tetrazole, and quaternary ammonium salt;
the oxyacid source is selected from the group consisting of sulfuric acid, ammonium sulfate, ammonium bisulfate, alkali metal sulfate, alkaline earth metal sulfate, phosphoric acid, ammonium phosphate, diamine hydrogen phosphate, ammonium dihydrogen phosphate, phosphoric acid ester, phosphorous acid, ammonium phosphite, phosphite, diethyl phosphite, tetraisopropyl titanate, tetra-n-butyl titanate, boric acid, boric acid ester, dimethyl sulfoxide, sulfolane;
the organic solvent is selected from the group consisting of alcohol, ketone or ester;
based on the precursor solution, a concentration of the organic amine is 1˜200 mg/mL, a concentration of the oxyacid source is 1˜200 mg/mL, and a concentration of the supramolecule compound is 1˜100 mg/mL.
